(19) United States
(12) Patent Application Publication
(10) Pub. No.: US 2024/0356287 A1
(43) Pub. Date: Oct. 24, 2024

(54) HIGH SPEED, HIGH PERFORMANCE ELECTRICAL CONNECTOR

(71) Applicant: Amphenol Commerical Products (Chengdu) Co., Ltd., Chengdu (CN)

(72) Inventors: Xiaodong Hu, Chengdu (CN); Lei Liao, Shenzhen (CN); Teng Cao, Chengdu (CN)

(73) Assignee: Amphenol Commerical Products (Chengdu) Co., Ltd., Chengdu (CN)

(21) Appl. No.: 18/638,178

(22) Filed: Apr. 17, 2024

(30) Foreign Application Priority Data
Apr. 18, 2023 (CN) 202310412354.6
Apr. 18, 2023 (CN) 202320862405.0

(51) Int. Cl. H01R 13/6585

(52) U.S. Cl. CPC H01R 13/6585

(57) ABSTRACT

The connector provides high performance transmission for high speed signals. The connector includes a subassembly having a subassembly housing holding conductive elements in a row and a shield disposed on the subassembly housing. The subassembly housing includes openings to ground conductive elements. The shield has ribs extending into the openings and contacting the ground conductors. The subassembly can have a second shield disposed closer to a mating face than the shield disposed on the subassembly housing. The second shield is configured to move with the mating ends of the conductive elements when a mating component is inserted into the connector. The connector has a housing with an opening positioned in a moving path of the second shield. Such a configuration meets signal integrity requirements in connectors design for 64 Gbps and beyond, while conforming to a standard that constrains connector physical dimensions.

### CROSS-REFERENCE TO RELATED APPLICATIONS

This application claims priority to and the benefit of Chinese Patent Application Serial No. 202320862405.0, filed on Apr. 18, 2023. This application also claims priority to and the benefit of Chinese Patent Application Serial No. 202310412354.6, filed on Apr. 18, 2023. The contents of these applications are incorporated herein by reference in their entirety.

### TECHNICAL FIELD

This application relates generally to interconnection systems, such as those including electrical connectors, used to interconnect electronic assemblies.

### BACKGROUND

Electrical connectors are used in many electronic systems. It is generally easier and more cost-effective to manufacture a system as separate electronic subassemblies, such as printed circuit boards (PCBs), which may be joined together by electrical connectors. Having separable electrical connectors enables components of the electronic system manufactured by different manufacturers to be readily assembled. Separable electrical connectors also enable components to be readily replaced after the system is assembled, either to replace defective components or to upgrade the system with higher performance components.

A known arrangement for joining several printed circuit boards is to have one printed circuit board serve as a backplane. A known backplane is a PCB onto which many electrical connectors may be mounted. Conducting traces in the backplane may be electrically connected to signal conductors in the electrical connectors so that signals may be routed between the electrical connectors. Other printed circuit boards, called “daughterboards,” “daughtercards,” or “midboards,” may be connected through the backplane. For example, daughtercards may also have electrical connectors mounted thereon. The electrical connectors mounted on a daughtercard may be plugged into the electrical connectors mounted on the backplane. In this way, signals may be routed among daughtercards through the electrical connectors and the backplane. The daughtercards may plug into the backplane at a right angle. The electrical connectors used for these applications may therefore each include a right angle bend and are often called “right angle electrical connectors”.

Electrical connectors may also be used in other configurations for interconnecting printed circuit boards. Sometimes, one or more printed circuit boards may be connected to another printed circuit board, called a “motherboard,” that is both populated with electronic components and interconnects to other printed circuit boards. In such a configuration, the printed circuit boards connected to the motherboard may be called “daughterboards”. The daughterboards are often smaller than the motherboard and may sometimes be aligned to be parallel to the motherboard. Electrical connectors used for this configuration are often called “stacking connectors” or “mezzanine connectors”. In other systems, the daughterboards may be perpendicular to the motherboard.

For example, this configuration is often used in computers in which the motherboard might have a processor and a bus configured to transmit data between the processor and peripherals, such as a graphics processor or memory. Electrical connectors may be mounted to the motherboard and connected to the bus. The peripherals may be implemented on daughtercards with connectors that mate with the connectors on the bus such that separately manufactured peripherals may be readily integrated into a computer made with the motherboard.

To enhance the availability of peripherals, the bus and the connectors used to physically connect peripherals via the bus may be standardized. In this way, there may be a large number of peripherals available from a multitude of manufacturers. All of those products, so long as they are compliant with the standard, may be used in a computer that has a bus compliant with the standard. Examples of such standards include serial ATA (SATA), serial attached SCSI (SAS), peripheral component interconnect express (PCIe), or SFF-8639, which are commonly used in computers. The standards have gone through multiple revisions, adapting to the higher performance expected from computers over time.

### BRIEF SUMMARY

Aspects of the present disclosure relate to high speed, high performance electrical connectors.

Some embodiments relate to a connector subassembly. The connector subassembly may include a plurality of conductive elements each comprising a mating end, a tail end opposite to the mating end, and an intermediate portion extending between the mating end and the tail end; a subassembly housing holding the plurality of conductive elements in a row and comprising a plurality of openings aligned with portions of the intermediate portions of selected ones of the plurality of conductive elements; and a shield comprising a body disposed on the subassembly housing and a plurality of ribs each extending from the body into a respective opening of the plurality of openings of the subassembly housing.

Optionally, the shield is coupled to the selected ones of the plurality of conductive elements through the plurality of ribs extend into the plurality of openings of the subassembly housing.

Optionally, the body of the shield comprises a plurality of openings each aligned with a respective opening of the plurality of openings of the subassembly housing; and each rib of the plurality of ribs of the shield extends from edges of a respective opening of the plurality of openings of the body of the shield.

Optionally, the body of the shield extends beyond the subassembly housing toward the tail ends of the plurality of conductive elements.

Optionally, for each of the plurality of conductive elements, the intermediate portion comprises a first subportion and a second subportion disposed closer to the mating end than the first subportion; the first subportions of the intermediate portions of the plurality of conductive elements are embedded in the subassembly housing; and each of the plurality of ribs extends toward a portion of the first subportion of the intermediate portion of a respective one of the selected ones of the plurality of conductive elements.

Optionally, the plurality of conductive elements comprise conductive elements configured for signal disposed between the selected ones configured for ground; and for each of the signal conductive elements: the first subportion of the intermediate portion is spaced from the body of the shield by a first distance; a center of the first subportion of the intermediate portion is spaced from an edge of the first subportion of the intermediate portion of an adjacent ground conductive element by a second distance; and the first distance is less than or equal to the second distance.

Optionally, the first subportion of the intermediate portion is separated from the body of the shield by the subassembly housing.

Optionally, for each of the plurality of conductive elements, the intermediate portion further comprises a third subportion disposed closer to the tail end than the first subportion; and the body of the shield extends beyond an edge of the subassembly housing and overlaps the third subportions of the intermediate portions of the plurality of conductive elements.

Optionally, the plurality of conductive elements comprise conductive elements configured for signal disposed between the selected ones configured for ground; the shield is a first shield; and the connector subassembly further comprises a second shield comprising a plateau disposed above at least a portion of the second subportion of the intermediate portion of a respective signal conductive element; and a valley attached to at least a portion of the second subportion of the intermediate portion of a respective ground conductive element.

Optionally, the second subportion of the intermediate portion of the signal conductive element is spaced from the plateau by a third distance; a center of the second subportion of the intermediate portion of the respective signal conductive element is spaced from an edge of the second subportion of the intermediate portion of the respective ground conductive element by a fourth distance; and the third distance is less than or equal to the fourth distance.

Some embodiments relate to an electrical connector. The electrical connector may include a housing comprising a side wall, the side wall comprising a first portion having a plurality of channels and a second portion having a space recessed into the side wall and aligned with the plurality of channels in a row; a plurality of conductive elements held in the subassembly housing, each of the plurality of conductive elements comprising a mating end, a tail end opposite to the mating end, and an intermediate portion extending between the mating end and the tail end, the plurality of conductive elements comprising a first plurality of conductive elements each disposed in a channel of the plurality of channels, and a second plurality of conductive elements disposed in the space; and a subassembly housing holding the second plurality of conductive elements in the space.

Optionally, the side wall comprises a third portion disposed between the first portion and the second portion and offset from the row, the third portion comprising a second plurality of channels; and the plurality of conductive elements comprise a third plurality of conductive elements each disposed in a channel of the second plurality of channels.

Optionally, the electrical connector includes a shield disposed between the subassembly housing and the second portion of the side wall, wherein: the second plurality of conductive elements comprise signal conductive elements disposed between ground conductive elements; the subassembly housing comprises a plurality of openings to intermediate portions of the ground conductive elements of the second plurality of conductive elements; and the shield comprises a plurality of rib each extending into a respective one of the plurality of openings of the subassembly housing.

Optionally, the shield is a first shield; the electrical connector comprises a second shield disposed closer to the mating ends of the second plurality of conductive elements than the first shield; and the second shield comprises a plurality of plateaus disposed above respective ones of the signal conductive elements and a plurality of valleys attached to respective ones of the ground conductive elements.

Optionally, the second portion of the side wall of the housing comprises an opening positioned in a moving path of the second shield.

Optionally, the side wall of the housing is a first side wall; the row is a first row; the housing comprises a second side wall opposite the first side wall and having a space recessed into the second side wall; the plurality of conductive elements comprise a fourth plurality of conductive elements disposed in the space of the second side wall of the housing; the subassembly housing is a first subassembly housing; and the electrical connector comprises a second subassembly housing holding the fourth plurality of conductive elements in the space of the second side wall of the housing in a second row parallel to the first row.

Optionally, the electrical connector may include a first shield disposed between the first subassembly housing and the second portion of the first side wall and electrically connected to selected ones of the second plurality of conductive elements; a second shield disposed on the second plurality of conductive elements and electrically connected to the selected ones of the second plurality of conductive elements at locations closer to the mating ends of the second plurality of conductive elements than the first shield; a third shield disposed between the second subassembly housing and the second side wall and electrically connected to selected ones of the fourth plurality of conductive elements; and at least one fourth shield disposed on the fourth plurality of conductive elements and electrically connected to the selected ones of the fourth plurality of conductive elements at locations closer to the mating ends of the fourth plurality of conductive elements than the third shield.

Optionally, the second portion of the first side wall of the housing comprises an opening positioned in a moving path of the second shield; and the second side wall of the housing comprises one or more openings positioned in a moving path of the at least one fourth shield.

Some embodiments relate to an electrical connector. The electrical connector may include a housing comprising a first side wall, a second side wall, and a slot disposed and elongated between the first and second side walls; a subassembly comprising a subassembly housing held by the first side wall and a plurality of conductive elements held in the subassembly housing, each of the plurality of conductive elements comprising a mating end curving into the slot, a tail end opposite the mating end and extending out of the housing, and an intermediate portion extending between the mating end and the tail end; and a shield disposed on the intermediate portions of the plurality of conductive elements of the subassembly and electrically connected to selected ones of the plurality of conductive elements and separated from the rest of the plurality of conductive elements.

Optionally, the shield is separated from the rest of the plurality of conductive elements by the subassembly housing or air.

Some embodiments relate to a terminal subassembly for an electrical connector. The terminal subassembly may comprise: a plurality of conductive elements each comprising a mating end, a tail end opposite to the mating end, and an intermediate portion extending between the mating end and the tail end, the plurality of conductive elements comprising a signal terminal and a plurality of ground terminals; a subassembly housing disposed around the intermediate portions of the plurality of conductive elements to retain the plurality of conductive elements so that the plurality of conductive elements are arranged in a row along a longitudinal direction, the subassembly housing comprising a plurality of openings each extending along a vertical direction perpendicular to the longitudinal direction to expose a portion of the intermediate portion of a corresponding one of the plurality of ground terminals; and a first shield comprising a body and a plurality of ribs extending from the body along the vertical direction, wherein the body may be disposed on the subassembly housing and each rib may be received in a corresponding one of the plurality of openings and electrically coupled to the portion of the intermediate portion of the corresponding ground terminal exposed by the corresponding opening.

Optionally, each rib comprises: a bottom portion electrically coupled to the portion of the intermediate portion of the corresponding ground terminal and having a first end and a second end opposite to each other in the longitudinal direction; and a first side portion and a second side portion opposite to each other in the longitudinal direction and connecting the first end and the second end of the bottom portion to the body, respectively.

Optionally, the body of the first shield comprises a plurality of openings each aligned with a corresponding one of the plurality of openings in the vertical direction, and comprising a first edge and a second edge opposite to each other in the longitudinal direction, and for each rib, the first side portion connects the first end of the bottom portion to the first edge of a corresponding opening, and the second side portion connects the second end of the bottom portion to the second edge of the corresponding opening.

Optionally, each opening further comprises a third edge and a fourth edge opposite to each other in a lateral direction perpendicular to the longitudinal direction and the vertical direction, the opening is bounded by the first edge, the second edge, the third edge and the fourth edge, and for each rib, the bottom portion, the first side portion and the second side portion are not connected to the third edge and the fourth edge of the corresponding opening.

Optionally, each rib has a U-shaped profile.

Optionally, each rib is a portion stamped out from the body.

Optionally, for each rib, the bottom portion is in direct contact with the portion of the intermediate portion of the corresponding ground terminal, and the direct contact is a surface contact.

Optionally, for each rib, the bottom portion is attached on the portion of the intermediate portion of the corresponding ground terminal.

Optionally, the subassembly housing is a member overmolded over the intermediate portions of the plurality of conductive elements.

Optionally, each rib is a U-shaped portion stamped out from the body and comprises a bottom, two ends opposite to each other in the longitudinal direction, and two edges opposite to each other in a lateral direction perpendicular to the longitudinal direction and the vertical direction, the bottom is electrically coupled to the portion of the intermediate portion of the corresponding ground terminal, the two ends are connected to the body, respectively, and the two edges are disconnected from the body, respectively.

Optionally, for each conductive element, the intermediate portion comprises a first subportion adjacent to the tail end and a second subportion adjacent to the mating end, the subassembly housing is disposed around the first subportions of the intermediate portions of the plurality of conductive elements to retain the plurality of conductive elements so that the first subportions are oriented in a lateral direction perpendicular to the longitudinal direction and the vertical direction and are aligned with each other in the longitudinal direction, the first subportions extend in a first plane perpendicular to the vertical direction, each of the plurality of openings of the subassembly housing exposes at least a portion of the first subportion of the intermediate portion of a corresponding one of the plurality of ground terminals, the body of the first shield is oriented to be parallel to the first plane, each of the plurality of ribs is received in a corresponding one of the plurality of openings and electrically coupled to at least the portion of the first subportion of the intermediate portion of the corresponding ground terminal exposed by the corresponding opening.

Optionally, at least one signal terminal is disposed between every two adjacent ground terminals of the plurality of ground terminals, the first subportion of the intermediate portion of the signal terminal is spaced from the body of the first shield by a first distance in the vertical direction, a center of the first subportion of the intermediate portion of the signal terminal is spaced from an edge of the first subportion of the intermediate portion of a corresponding adjacent ground terminal by a second distance in the longitudinal direction, the first distance is less than or equal to the second distance.

Optionally, the first subportion of the intermediate portion of the signal terminal is separated from the body of the first shield by the subassembly housing in the vertical direction.

Optionally, the extended range of the body of the first shield in the longitudinal direction covers at least the first subportions of the intermediate portions of the signal terminal and the plurality of ground terminals.

Optionally, the extended range of the body of the first shield in the lateral direction covers at least the first subportion of the intermediate portion of each of the signal terminal and the plurality of ground terminals.

Optionally, for each conductive element, the intermediate portion further comprises a third subportion extending from the first subportion along the lateral direction and extending outside the subassembly housing to connect the tail end, and the body of the first shield extends beyond an edge of the subassembly housing in the lateral direction so that the extended range of the body of the first shield in the lateral direction covers the third subportion of the intermediate portion of each of the signal terminal and the plurality of ground terminals.

Optionally, for each conductive element, the tail end comprises a straight portion and a curved portion, the curved portion extends between the straight portion and the third subportion of the intermediate portion, and is bent towards the body of the first shield so that the straight portion and the third portion are oriented to be perpendicular to each other.

Optionally, the subassembly housing comprises a flat first face extending parallelly to the first plane, the plurality of openings are recessed into the subassembly housing from the first face along the vertical direction, the body of the first shield comprises a flat second face, the plurality of ribs are arranged to protrude from the second face, and the body is disposed on the subassembly housing so that the second face of the body is disposed on the first face of the subassembly housing and each rib is received in a corresponding one of the plurality of openings.

Optionally, the terminal subassembly further comprises a second shield comprising at least one shield, each of the shields comprises a plateau and a valley, each plateau extends between two corresponding adjacent valleys of the valleys, at least one signal terminal is disposed between every two adjacent ground terminals of the plurality of ground terminals, and for each shield, each valley is attached on at least a portion of the second subportion of the intermediate portion of the corresponding one of the plurality of ground terminals, so that a plateau extending between two adjacent valleys is positioned above the second subportion of the intermediate portion of the corresponding at least one signal terminal, wherein the corresponding at least one signal terminal is located between two adjacent ground terminals corresponding to the two corresponding adjacent valleys.

Optionally, the second subportions of the intermediate portions of the plurality of conductive elements are aligned with each other in the longitudinal direction and extend in a second plane parallel to the longitudinal direction and inclined with respect to the first plane, and for each shield, each plateau is oriented to be parallel to the second plane.

Optionally, the second subportion of the intermediate portion of the signal terminal is spaced from the corresponding plateau by a third distance in a direction perpendicular to the second plane, a center of the second subportion of the intermediate portion of the signal terminal is spaced from an edge of the second subportion of the intermediate portion of a corresponding adjacent ground terminal by a fourth distance in the longitudinal direction, the third distance is less than or equal to the fourth distance.

Optionally, for each conductive element, the intermediate portion comprises a first broadside and a second broadside opposite to each other, for the first shield, each rib is electrically coupled to at least a portion of the first subportion of the intermediate portion on the first broadside of the intermediate portion of a corresponding ground terminal, and for the second shield, each valley of each of the shields is attached to at least a portion of the second subportion of the intermediate portion on the first broadside of the intermediate portion of the corresponding ground terminal.

Optionally, the terminal subassembly is configured to be used in a receptacle connector, and for each conductive element, the mating end comprises a third broadside and a fourth broadside opposite to each other, the third broadside is connected to the first broadside and the fourth broadside is connected to the second broadside, the mating end further comprises a mating contact surface on the fourth broadside.

Some embodiments relate to an electrical connector. The electrical connector may comprise the aforementioned terminal subassembly; and a housing comprising a mating face and an space recessed into the housing from the mating face along a lateral direction perpendicular to the longitudinal direction and the vertical direction, the subassembly housing and the first shield of the terminal subassembly are held in the space by the housing.

Optionally, the housing comprises a plurality of section walls bounding the space, the subassembly housing and the first shield are configured to be inserted into the space from an entrance of the space in the lateral direction and to be held in the space by engaging with the plurality of section walls, at least one of the plurality of section walls comprises a bump protruding into the space and extending in the lateral direction, the height of the bump gradually increases as the bump extends in the lateral direction away from the entrance of the space.

Optionally, the housing comprises a first section wall and a second section wall opposite to each other in the longitudinal direction and bounding the space, a first groove recessed into the first section wall in the longitudinal direction and a second groove recessed into the second section wall in the longitudinal direction, the subassembly housing comprises a first end face and a second end face opposite to each other in the longitudinal direction, a first tab extending from the first end face in the longitudinal direction, and a second tab extending from the second end face in the longitudinal direction, when the subassembly housing is disposed in the space, the first tab and the second tab engage with the first groove and the second groove, respectively, to limit the movement of the subassembly housing relative to the housing in the vertical direction and the longitudinal direction.

Optionally, the housing further comprises a third section wall bounding the space in the vertical direction, and the space extends from the third section wall through the housing in the vertical direction to form an open portion, the body of the first shield is exposed through the open portion.

Some embodiments relate to an electrical connector. The electrical connector may comprise a housing comprising: a body; a first wall, a second wall, a third wall, and a fourth wall extending from the body along a lateral direction on a first side of the body and bounding a slot, the first wall and the second wall opposite to each other in a vertical direction perpendicular to the lateral direction, and the third wall and the fourth wall being opposite to each other in a longitudinal direction perpendicular to the lateral direction and the vertical direction; a first space recessed into the body in the lateral direction from a second side of the body opposite to the first side; and a second space recessed into the first wall from the slot in the vertical direction and extending along the lateral direction to communicate with the first space; a terminal subassembly comprising: a plurality of conductive elements each comprising a mating end, a tail end opposite to the mating end, and an intermediate portion extending between the mating end and the tail end, the mating end comprising a mating contact portion, the intermediate portion comprising a first subportion adjacent to the tail end and a second subportion adjacent to the mating end, the plurality of conductive elements comprising a signal terminal and a plurality of ground terminals; a subassembly housing disposed around the first subportions of the intermediate portions of the plurality of conductive elements to retain the plurality of conductive elements, so that the plurality of conductive elements are arranged in a row along the longitudinal direction; and at least one shield each comprising a plateau and a valley, each of the valleys attached on at least a portion of the second subportion of the intermediate portion of a corresponding one of the plurality of ground terminals; wherein the subassembly housing is disposed in the first space with the second subportions of the intermediate portions of the plurality of conductive elements and the at least one wave-shaped shield disposed in the second space and with the mating contact portions of the mating ends of the plurality of conductive elements exposed in the slot.

Optionally, the at least one wave-shaped shield is located on a side of the plurality of conductive elements opposite to the slot, the first wall comprises at least one first opening each extending in the vertical direction to expose a corresponding one of the at least one shield.

Optionally, the second subportions of the intermediate portions and the mating ends of the plurality of conductive elements extend in a cantilevered manner, each first opening is configured so that when the second subportions of the ground terminals are deflected away from the slot in the vertical direction, a corresponding one of the wave-shaped shields can be moved into the first opening without interfering with the first wall.

Optionally, at least one signal terminal is disposed between every two adjacent ground terminals of the plurality of ground terminals, and for each shield, each plateau extends between two corresponding adjacent valleys of the valleys and is positioned above the second subportion of the intermediate portion of the corresponding at least one signal terminal, wherein the corresponding at least one signal terminal is located between two adjacent ground terminals corresponding to the two corresponding adjacent valleys.

Optionally, the first wall comprises a plurality of channels each extending from the second space into the first wall in the lateral direction, and a plurality of shelves each separating a corresponding one of the plurality of channels from the slot in the vertical direction; and for each conductive element, a tip of the mating end is received in a corresponding one of the plurality of channels and is limited by a corresponding one of the plurality of retaining portions to be prevented from moving into the slot.

Optionally, the subassembly housing comprises a plurality of second openings each extending in the vertical direction to expose at least a portion of the first subportion of the intermediate portion of a corresponding one of the plurality of ground terminals; the terminal subassembly further comprising a first shield comprising a body and a plurality of ribs extending from the body, the body is disposed on the subassembly housing on a side of the plurality of conductive elements opposite to the slot, and each rib is received in a corresponding second opening of the plurality of second openings and electrically coupled to at least a portion of the first subportion of the intermediate portion of a corresponding one of the grounded terminals exposed by the corresponding second opening; the subassembly housing and the first shield are held in the first space by the housing; and the housing further comprises a first section wall and a second section wall opposite to each other in the longitudinal direction and bounding the first space, and a third section wall bounding the first space in the vertical direction, and the first space extends from the third section wall through the housing in the vertical direction to form an open portion, the body of the first shield is exposed through the open portion.

Some embodiments relate to an electrical connector. The electrical connector may comprise a housing comprising: a body; a first wall, a second wall, a third wall and a fourth wall extending from the body in a lateral direction on a first side of the body and bounding a slot, the first wall and the second wall opposite to each other in a vertical direction perpendicular to the lateral direction, and the third wall and the fourth wall opposite to each other in a longitudinal direction perpendicular to the lateral direction and the vertical direction; a first space recessed into the body in the lateral direction from a second side of the body opposite to the first side; and a second space recessed from the slot into the first wall in the vertical direction and extending along the lateral direction to communicate with the first space; a terminal subassembly comprising: a plurality of conductive elements each comprising a mating end, a tail end opposite to the mating end, and an intermediate portion extending between the mating end and the tail end, the mating end comprising a mating contact portion, the intermediate portion comprising a first subportion adjacent to the tail end and a second subportion adjacent to the mating end, and the plurality of conductive elements comprising a signal terminal and a plurality of ground terminals; a subassembly housing disposed around the first subportions of the intermediate portions of the plurality of conductive elements to retain the plurality of conductive elements, so that the plurality of conductive elements are arranged in a row along the longitudinal direction; a first shield disposed on the subassembly housing and electrically coupled to the first subportions of the intermediate portions of at least two of the plurality of ground terminals; and a second shield comprising at least one shield each comprising a plateau and a valley, each of the valleys attached to at least a portion of the second subportion of the intermediate portion of a corresponding one of the plurality of ground terminals; wherein the subassembly housing and the first shield are held in the first space by the housing with the second subportions of the intermediate portions of the plurality of conductive elements and the second shield disposed in the second space and with the mating contact portions of the mating ends of the plurality of conductive elements exposed in the slot.

Optionally, the subassembly housing comprises a plurality of openings each extending in the vertical direction to expose at least a portion of the first subportion of the intermediate portion of a corresponding one of the plurality of ground terminals; and the first shield comprises a plate-like body and a plurality of ribs extending from the body in the vertical direction, the body is disposed on the subassembly housing and each rib is received in a corresponding one of the plurality of openings and electrically coupled to at least the portion of the first subportion of the intermediate portion of the corresponding ground terminal exposed by the corresponding opening.

Optionally, at least one signal terminal is disposed between every two adjacent ground terminals of the plurality of ground terminals; and for each shield, each plateau extends between two corresponding adjacent valleys of the valleys and is positioned above the second subportion of the intermediate portion of the corresponding at least one signal terminal, wherein the corresponding at least one signal terminal is located between two adjacent ground terminals corresponding to the two corresponding adjacent valleys.

Optionally, the first shield and the second shield are located on a side of the plurality of conductive elements opposite to the slot.

These techniques may be used alone or in any suitable combination. The foregoing summary is provided by way of illustration and is not intended to be limiting.

### BRIEF DESCRIPTION OF DRAWINGS

The accompanying drawings may not be drawn to scale. In the drawings, each identical or nearly identical component that is illustrated in various figures may be represented by a like numeral. For purposes of clarity, not every component may be labeled in every drawing. In the drawings:

FIG. 1 is a top, front perspective view of an electrical connector, according to some embodiments;

FIG. 2 is a top, rear perspective view of the electrical connector of FIG. 1;

FIG. 3 is a partially exploded front, bottom perspective view of the electrical connector of FIG. 1;

FIG. 4 is a front, bottom perspective view of the electrical connector of FIG. 1;

FIG. 5A is a top view of the electrical connector of FIG. 1;

FIG. 5B is a front view of the electrical connector of FIG. 1;

FIG. 5C is a rear view of the electrical connector of FIG. 1;

FIG. 5D is a bottom view of the electrical connector of FIG. 1;

FIG. 6A is a cross-sectional view of the electrical connector of FIG. 1 taken along a line marked “I-I” in FIG. 5B;

FIG. 6B is a cross-sectional view of the electrical connector of FIG. 1 taken along a line marked “II-II” in FIG. 5B;

FIG. 7A is a front, bottom perspective view of the electrical connector of FIG. 1, with a housing hidden, illustrating a first terminal subassembly, a second terminal subassembly, and a plurality of individual conductive elements in the housing;

FIG. 7B is an enlarged view of an area marked “7B” by dashed lines in FIG. 7A;

FIG. 8A is a rear perspective view of the housing of the electrical connector of FIG. 1;

FIG. 8B is a bottom, rear perspective view of the housing of FIG. 8A;

FIG. 8C is a top, front perspective view of the housing of FIG. 8A;

FIG. 8D is a front perspective view of the housing of FIG. 8A;

FIG. 9A is a perspective view of the first terminal subassembly of the electrical connector of FIG. 1, illustrating a plurality of conductive elements, a subassembly housing, a first shield, and a second shield;

FIG. 9B is an exploded perspective view of the first terminal subassembly of FIG. 9A;

FIG. 9C is a top view of the first terminal subassembly of FIG. 9A;

FIG. 9D is a bottom view of the first terminal subassembly of FIG. 9A;

FIG. 9E is a cross-sectional view of the first terminal subassembly of FIG. 9A taken along a line marked “III-III” in FIG. 9C;

FIG. 9F is a side view of the first terminal subassembly of FIG. 9A;

FIG. 10A is a perspective view of the first shield of the first terminal subassembly of FIG. 9A;

FIG. 10B is an enlarged view of the area marked “10B” by dashed lines in FIG. 10A;

FIG. 10C is another perspective view of the first shield of FIG. 10A;

FIG. 10D is an enlarged view of the area marked “10D” by dashed lines in FIG. 10C;

FIG. 11A is a perspective view of the second shield of the first terminal subassembly of FIG. 9A;

FIG. 11B is another perspective view of the second shield of FIG. 11A;

FIG. 12A is a perspective view of a group of four conductive elements of the first terminal subassembly of FIG. 9C circled by the dashed frame “12a”;

FIG. 12B is another perspective view of the group of four conductive elements of FIG. 12A;

FIG. 13A is a perspective view of the second terminal subassembly of the electrical connector of FIG. 1, illustrating a plurality of conductive elements, a subassembly housing, a third shield, and a fourth shield; and

FIG. 13B is an exploded view of the second terminal subassembly of FIG. 13A.

### LIST OF REFERENCE NUMBERS

X-X lateral direction
Y-Y longitudinal direction
Z-Z vertical direction
1 electrical connector
100 housing
101 body
101a mounting face of the body
103 slot
104 mating face
105 first space
105a entrance of the first space
106 second space
107 third space
107a open portion
108 fourth space
110 first wall
111 opening in the first wall
112 opening in the first wall
113 opening in the first wall
114 channel
115 shelf
120 second wall
121 opening in the second wall
130 third wall
140 fourth wall
151 first section wall
152 second section wall
153 third section wall
154 fourth section wall
155 fifth section wall
156 sixth section wall
157 seventh section wall
152a bump
155a first groove
156a second groove
160 channel
300 first terminal subassembly
200 conductive element
200g ground terminal
200s signal terminal
201 mating end
2011 third broadside of the mating end
2012 fourth broadside of the mating end
201a mating contact portion
201b mating contact surface
201c tip of the mating end
202 tail end
202a straight portion of tail end
202b bent portion of tail end
203 intermediate portion
203a first subportion of the intermediate portion
203b second subportion of the intermediate portion
203c third subportion of the intermediate portion
2031 first broadside of the intermediate portion
2032 second broadside of the intermediate portion
2033 first edge of the intermediate portion
2034 second edge of the intermediate portion
P1 first plane
P2 second plane
700 subassembly housing
701 opening in the subassembly housing
703 first face of the subassembly housing
705 edge of the subassembly housing
800 first shield
801 body
801a second face of the body
810 rib
811 bottom portion of the rib
811a first end of the bottom portion of the rib
811b second end of the bottom portion of the rib
812 first side portion of the rib
813 second side portion of the rib
815, 816 end portions of the rib
817, 818 edges of the rib
820 opening of the body
821 first edge of the opening
822 second edge of the opening
823 third edge of the opening
824 fourth edge of the opening
900 second shield
900a plateau
900b valley
901, 902, 903 shields
500 second terminal subassembly
400 conductive element
400s signal terminal
400g ground terminal
401 mating end
401a mating contact portion of the mating end
403 intermediate portion
403b second subportion of the intermediate portion
1000 subassembly housing
1001 first end face
1002 second end face
1003 first tab
1004 second tab
1100 third shield
1101 body of the third shield
1200 fourth shield
600 conductive element.

### DETAILED DESCRIPTION

The inventors have recognized and appreciated electrical connector design techniques that satisfy electrical and mechanical requirements to support greater bandwidth through high frequency operation. Some of these techniques can synergistically support higher frequency electrical connector operation and satisfy the physical requirements set by industry standards such as SFF-8639.

In some embodiments, an electrical connector may include one or more subassemblies. Each subassembly may include signal conductive elements disposed between ground conductive elements, and a subassembly housing holding the signal and ground conductive elements in a row. The subassembly housing may be configured to block contaminants from entering the connector from a mounting interface and/or accumulating on the conductive elements.

In some examples the subassembly housings and/or a connector housing receiving the subassemblies may be configured to simply and economically integrate conductive members for improving electrical performance of the connector without impacting the mating or mounting interfaces of the connector, which may be configured for compliance with a standard. The conductive members, for example, may be elongated in a longitudinal direction and may be connected to or electrically coupled to one or more of the conductive elements in a row. These conductive elements may be referred to as “shields,” whether or not their primary mechanism for improving electrical performance of the connector is blocking electromagnetic radiation.

In some examples, a first shield, mounted against a surface of a subassembly housing may be stamped with ribs that extend into openings of the subassembly housing through which ground conductors are exposed. The ribs may be attached to, or otherwise be coupled to, multiple ground conductors in a row. Alternatively or additionally, one or more walls of the connector housing adjacent mating contact portions of the ground conductors may have openings therein. Those openings may communicate with a slot in the connector housing configured to receive a mating component. Those openings may be sized and positioned to receive one or more second shields, each of which may be attached to the mating contact portions of multiple ground conductors in a row. The openings may be sufficiently large that the walls of the housing do not interfere with the second shields, even when the ground conductors are deflected in response to a mating component inserted into the slot. In some examples, the openings in a wall of the connector housing may extend entirely through the wall such that one or more second shields may be attached to the ground conductors after the terminal assembly is inserted into the connector housing.

In some embodiments, a shield may be disposed on the subassembly housing. The subassembly housing may include openings to ground conductive elements. In some embodiments, the shield may be electrically connected to the ground conductive elements. The shield may have ribs extending into the openings. The ribs may contact the ground conductors. Such a configuration enables the subassembly housing and the shield to be disposed within the boundaries of the housing, which may be set by an industry standard such as SFF-8639.

In some embodiments, each subassembly may have a second shield disposed closer to a mating face than the shield disposed on the subassembly housing. The second shield may be configured to move with the mating ends of the conductive elements when a mating component is inserted into the connector. The second shield may include plateaus disposed on and separate from the signal conductive elements (e.g., by air), and valleys attached to the ground conductive elements.

In some embodiments, the connector may have a housing with one or more spaces recessed into side walls of the housing. Each space may receive a subassembly. The side walls of the housing may include openings positioned in a moving path of the second shields of the subassemblies. Such a configuration enables the second shields to operate within the boundaries of the housing, which may be set by an industry standard such as SFF-8639.

In some embodiments, a terminal subassembly for an electrical connector may include a plurality of conductive elements, a subassembly housing, and a first shield. Each conductive element may include a mating end, a tail end opposite to the mating end, and an intermediate portion extending between the mating end and the tail end. The plurality of conductive elements may include a signal terminal and a plurality of ground terminals. The subassembly housing may be disposed around the intermediate portions of the plurality of conductive elements to retain the plurality of conductive elements so that the plurality of conductive elements are arranged in a row in a longitudinal direction. The subassembly housing may include a plurality of openings each extending in a vertical direction perpendicular to the longitudinal direction to expose a portion of the intermediate portion of a corresponding one of the plurality of ground terminals. The first shield may include a body and a plurality of ribs extending from the body along the vertical direction. The body may be disposed on the subassembly housing, and each rib may be received in a corresponding one of the plurality of openings and is electrically coupled to a portion of the intermediate portion of the corresponding ground terminal exposed by the corresponding opening. Such a configuration enables provide shielding protection to the signal terminal and reduce crosstalk to improve signal integrity, thereby improving the signal transmission performance of the electrical connector.

Alternatively or additionally, the terminal subassembly may further comprise one or more second shields. Each shield may include a plateau and a valley. Each plateau may extend between two corresponding adjacent valleys of the valleys. At least one signal terminal may be disposed between every two adjacent ground terminals of the plurality of ground terminals. For each shield, each valley may be attached on at least a portion of the second subportion of the intermediate portion of a corresponding one of the plurality of ground terminals so that the plateau extending between the two adjacent valleys is positioned above the second subportion of the intermediate portion of the corresponding at least one signal terminal. The corresponding at least one signal terminal may be located between the two adjacent ground terminals corresponding to the two adjacent valleys. Such a configuration enables providing shielding protection to the signal terminal and reduce crosstalk to improve signal integrity, thereby further improving the signal transmission performance of the electrical connector.

In some embodiments, an electrical connector may include a housing having a body, a first wall, a second wall, a third wall, and a fourth wall extending in a lateral direction from the body on a first side of the body and bounding a slot. The first wall and the second wall may be opposite to each other in a vertical direction perpendicular to the lateral direction. The third wall and the fourth wall may be opposite to each other in a longitudinal direction perpendicular to the transverse and vertical directions. The housing may include a first space recessed into the body in the lateral direction from a second side of the body opposite to the first side; and a second space recessed into the first wall in the vertical direction from the slot and extending in the lateral direction to communicate with the first space. The subassembly housing and the first shield of the terminal subassembly may be held in the first space by the housing, with the second subportions of the intermediate portions of the plurality of conductive elements and the second shield disposed in the second space, and with mating contact portions of the mating ends of the plurality of conductive elements exposed in the slot. With such a configuration, the first shield and the second shield of the terminal subassembly may be disposed within the boundary of the housing, and thus the first shield and the second shield may not increase the size of the electrical connector in the vertical direction Z-Z, which facilitates miniaturization of the electrical connector. Further, the terminal subassembly may reduce or eliminate the need to form channels in the housing for holding conductive elements, which may increase manufacturing efficiency and reduce manufacturing cost.

Some embodiments of the present application are described in detail below in conjunction with the accompanying drawings. It should be appreciated that these embodiments are not intended to form any limitations to the present application. Moreover, features in the embodiments of the present application can be used alone or in any suitable combination.

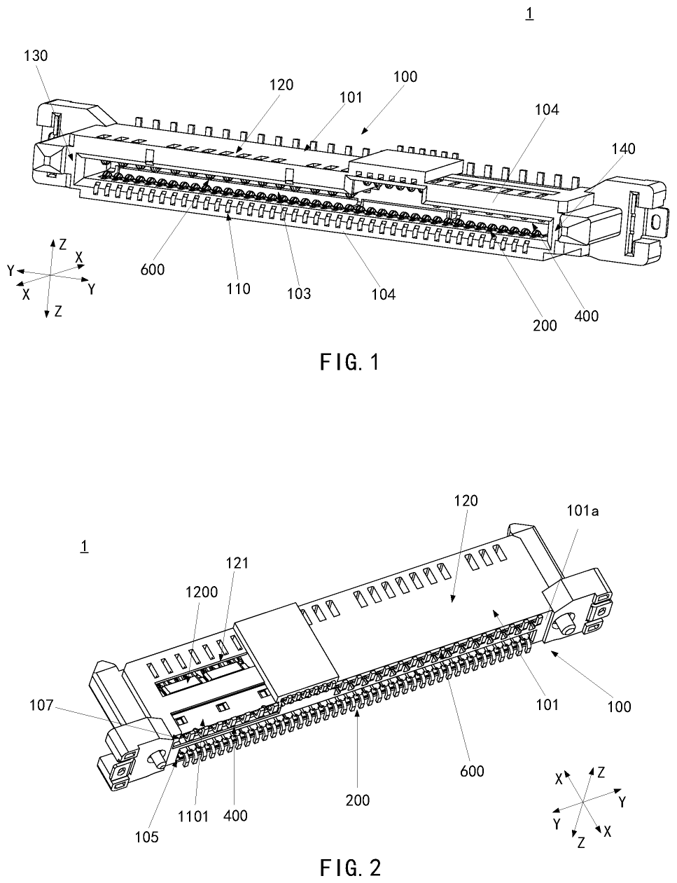

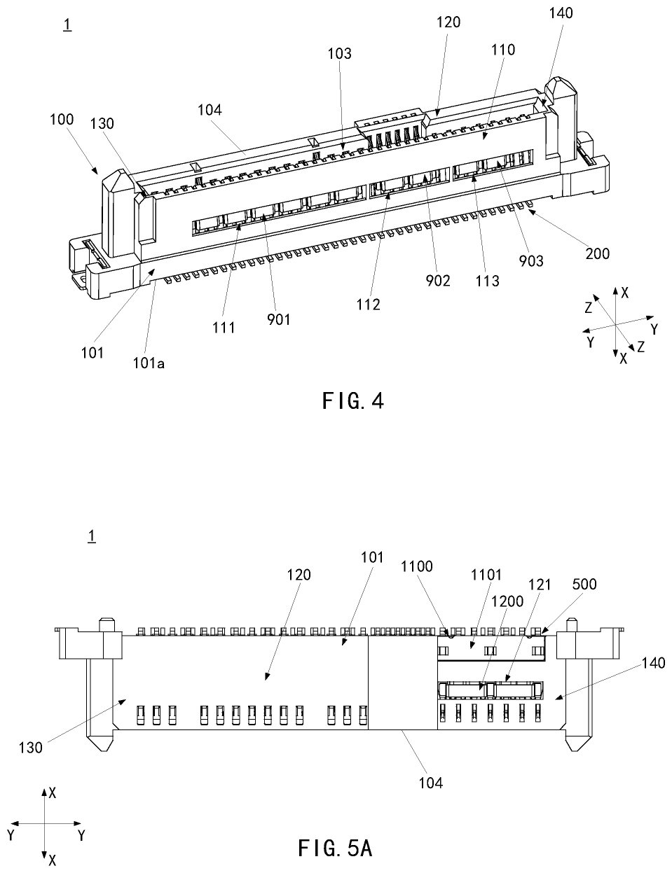

FIGS. 1 to 13B illustrate an electrical connector 1 according to some embodiments of the present application. A lateral direction X-X, a longitudinal direction Y-Y and a vertical direction Z-Z may be referred to. The lateral direction X-X, the longitudinal direction Y-Y and the vertical direction Z-Z may be perpendicular to each other. The lateral direction X-X may refer to the height direction of the electrical connector 1. The longitudinal direction Y-Y may refer to the length direction of the electrical connector 1. The vertical direction Z-Z may refer to the width direction of the electrical connector 1.

As shown in FIGS. 1 to 6B, the electrical connector 1 may be configured as a receptacle connector, especially a receptacle connector compliant with SSF-8639, to be combined with a mating plug connector (not shown) to constitute an electrical connector assembly. Such an electrical connector assembly can provide an industry-standard interface such as SFF-8639 to establish an electrical connection between a storage drive (such as a hard disk drive (HDD), a solid state drive (SSD), an optical disk drive (ODD)) and a circuit board (such as a backplane, a midplane, a drive carrier board). The electrical connector 1 may be mounted to the circuit board, and the plug connector may connect the storage drive to the electrical connector 1, whereby the electrical connector 1 can establish an electrical connection between the circuit board and the plug connector, and the plug connector can establish an electrical connection between the storage drive and the electrical connector 1. In this way, the electrical connector assembly comprising the electrical connector 1 and the plug connector can establish an electrical connection between the storage drive and the circuit board.

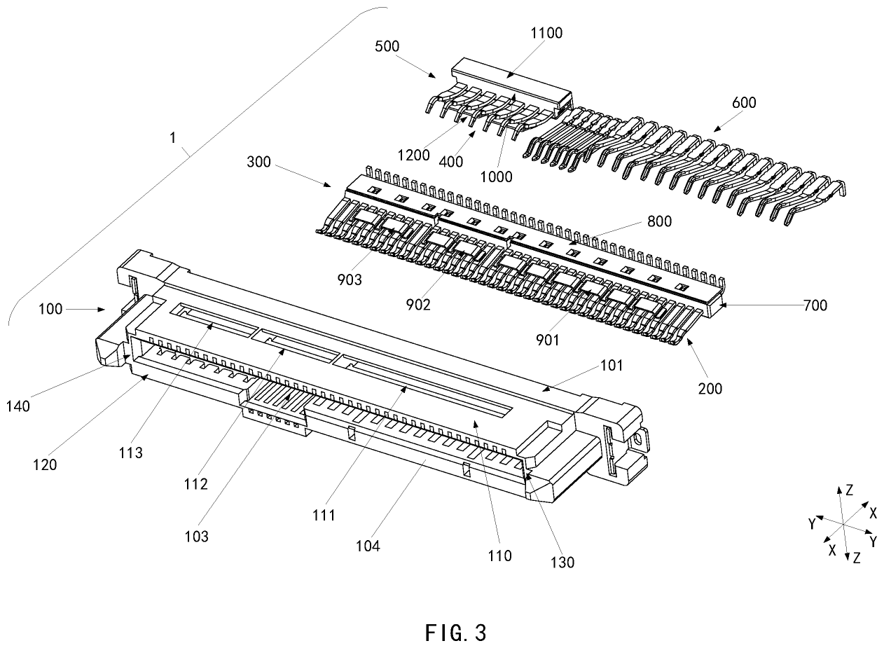

As illustrated in FIG. 3, the electrical connector 1 includes a housing 100, a first terminal subassembly (which may also be referred to as “a first connector subassembly”) 300 having a plurality of conductive elements 200, a second terminal subassembly (which may also be referred to as “a second connector subassembly”) 500 having a plurality of conductive elements 400, and a plurality of individual conductive elements 600.

As shown in FIGS. 1 to 6B and FIGS. 8A to 8D, the housing 100 includes a body 101, and a first wall 110, a second wall 120, a third wall 130, and a fourth wall 140 extending from the body 101 in a lateral direction X-X on a first side of the body 101 and bounding a slot 103. The first wall 110 and the second wall 120 are opposed to each other in a vertical direction Z-Z perpendicular to the lateral direction X-X, and the third wall 130 and the fourth wall 140 are opposed to each other in a longitudinal direction Y-Y perpendicular to the lateral direction X-X and the vertical direction Z-Z. For example, the opposite ends of the first wall 110 are connected to a first end of the third wall 130 and a first end of the fourth wall 140, respectively, and the opposite ends of the second wall 120 are connected to a second end of the third wall 130 opposite to the first end and a second end of the fourth wall 140 opposite to the first end, respectively. The distance by which the first wall 110 and the second wall 120 are spaced in the vertical direction Z-Z, and may be referred to as a width of the slot 103, and the distance by which the third wall 130 and the fourth wall 140 are spaced in the longitudinal direction Y-Y, and may be referred to as a length of the slot 103. The first wall 110, the second wall 120, the third wall 130, and the fourth wall 140 may comprise a mating face 104 of the housing 100 on a side opposite to the body 101. Accordingly, the slot 103 is recessed into the housing 100 from the mating face 104 of the housing 100 in the lateral direction X-X. The distance between the mating face 104 and the body 101 in the lateral direction X-X, and may be referred to as the depth of the slot 103.

The housing 100 may be formed from an insulative material. Examples of insulative materials that are suitable for forming the insulative housing 100 include, but are not limited to, plastic, nylon, liquid crystal polymer (LCP), polyphenylene sulfide (PPS), high temperature nylon or polyphenylene oxide (PPO) or polypropylene (PP). The insulative housing 100 may be formed by any suitable manufacturing process in the art, such as injection molding.

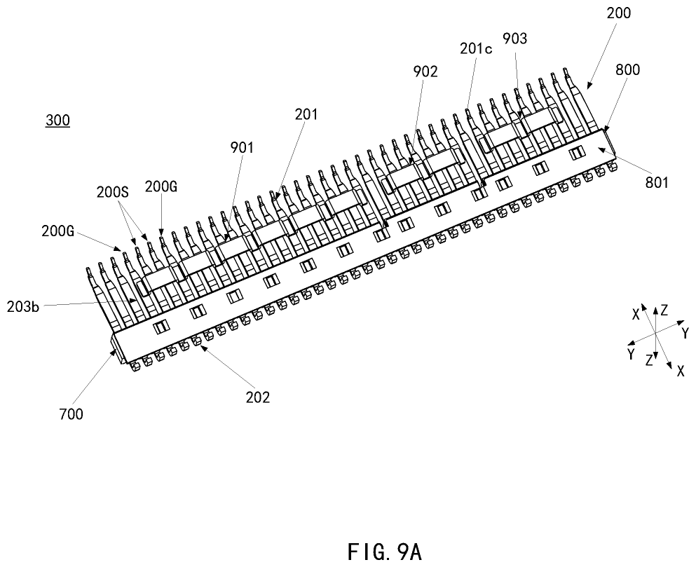

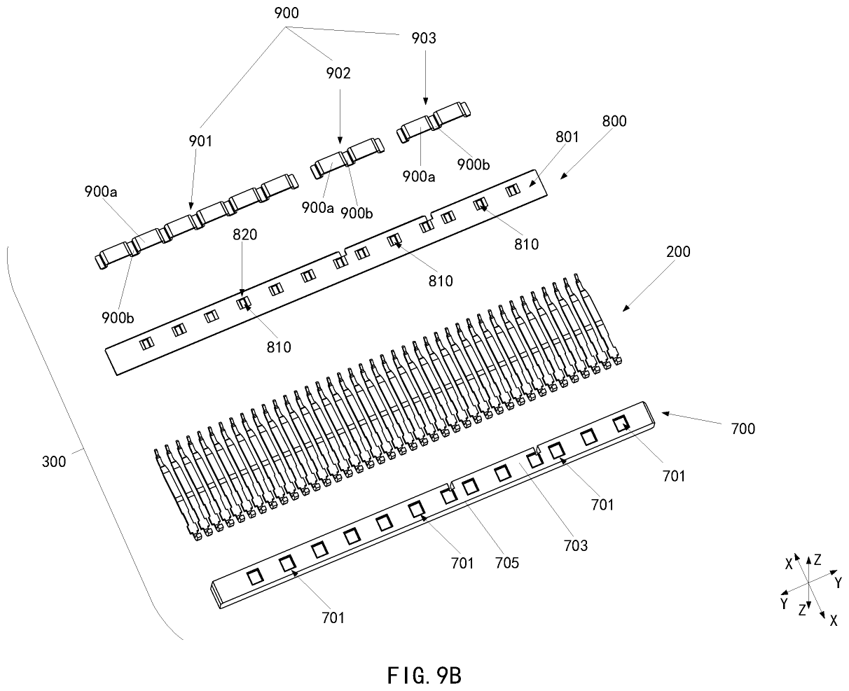

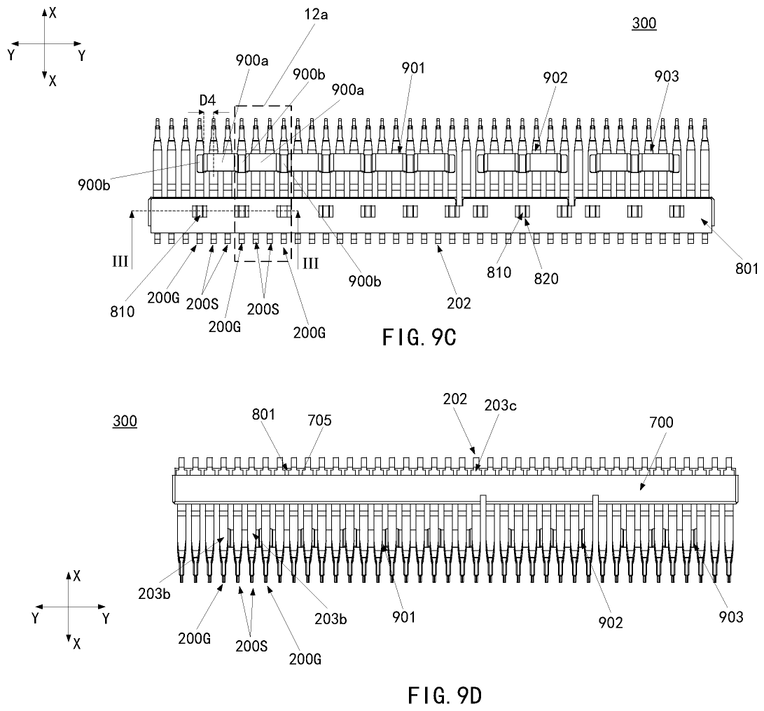

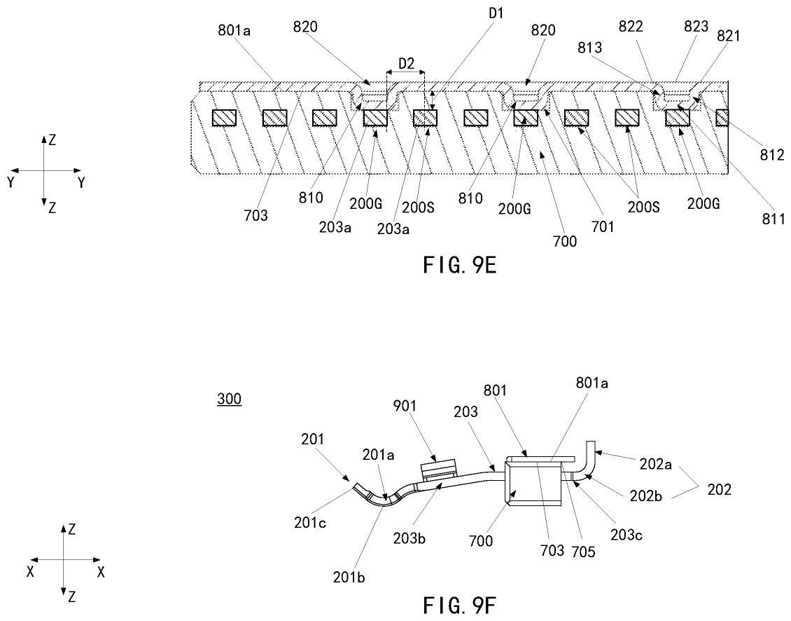

The first terminal subassembly 300 is configured to be disposed in the housing 100 and is configured to improve signal transmission performance of the electrical connector 1. As shown in FIGS. 9A to 12B, the first terminal subassembly 300 includes a plurality of conductive elements 200, a subassembly housing 700, a first shield 800, and a second shield 900.

Each conductive element 200 may be formed from an electrically conductive material. The electrically conductive material suitable for forming the conductive elements 200 may be a metal or metal alloy, such as copper or copper alloy. Each conductive element 200 includes a mating end 201, a tail end 202 opposite to the mating end 201, and an intermediate portion 203 extending between the mating end 201 and the tail end 202. As will be described in detail below, the mating end 201 may be configured to mate with a corresponding conductive portion of the aforementioned plug connector, and the tail end 202 may be configured to be connected to a corresponding conductive portion of the aforementioned circuit board. The plurality of conductive elements 200 includes a signal terminal 200S and a plurality of ground terminals 200G. For example, the plurality of conductive elements 200 may include at least one signal terminal 200S and at least two ground terminals 200G.

The subassembly housing 700 may be formed from an insulative material. Examples of insulative materials that are suitable for forming the subassembly housing 700 include, but are not limited to, plastic, nylon, liquid crystal polymer (LCP), polyphenylene sulfide (PPS), high temperature nylon or polyphenylene oxide (PPO) or polypropylene (PP). As shown in FIGS. 9A and 9C to 9F, the subassembly housing 700 is disposed around the intermediate portions 203 of the plurality of conductive elements 200 to retain the plurality of conductive elements 200 so that the plurality of conductive elements 200 are arranged in a row along the longitudinal direction Y-Y, i.e., arranged in a terminal row. The plurality of conductive elements 200 are aligned in the terminal row and spaced from each other. In some embodiments, the subassembly housing 700 may be a member overmolded over the intermediate portions 203 of the plurality of conductive elements 200. In some other embodiments, the subassembly housing 700 may be pre-fabricated and the intermediate portions 203 of the plurality of conductive elements 200 may be inserted in the subassembly housing 700.

At least one signal terminal 200S is disposed between every two adjacent ground terminals 200G of the plurality of ground terminals 200G. In some embodiments, a pair of signal terminals 200S may be disposed between two adjacent ground terminals 200G. For example, the plurality of conductive elements 200 may include a plurality of pairs of signal terminals 200S, each pair of signal terminals 200S is configured to transmit a differential signal. One of the pair of signal terminals 200S may be energized by a first voltage, and the other signal terminal may be energized by a second voltage. The voltage difference between the pair of signal terminals 200S represents a signal. The ground terminals 200G may separate the plurality of pairs of signal terminals 200S from each other. For example, the ground terminals 200G and signal terminals 200S may be arranged in a “G-S-S-G-S-S . . . G-S-S” pattern, with two adjacent pairs of signal terminals 200S sharing a ground terminal 200G. Using ground terminals 200G to separate the plurality of pairs of signal terminals 200S from each other can reduce crosstalk and thus improve signal integrity. As another example, one signal terminal 200S or more than two signal terminals 200S may be disposed between two adjacent ground terminals 200G.

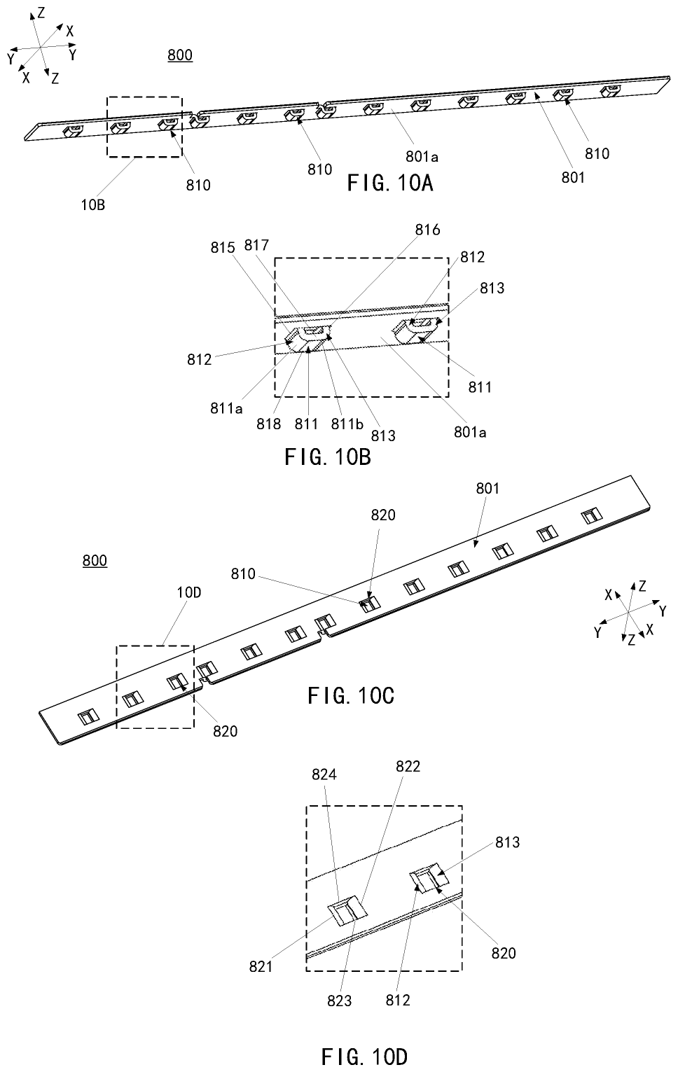

As shown in FIG. 9B, the subassembly housing 700 includes a plurality of openings 701 each extending along the vertical direction Z-Z to expose a portion of the intermediate portion 203 of a corresponding one of the plurality of ground terminals 200G. The plurality of openings 701 may be formed by any suitable process known in the art, for example, the plurality of openings 701 may be formed during overmolding of the subassembly housing 700 over the intermediate portion 203 of the plurality of conductive elements 200. As shown in FIGS. 9B and 10A to 10D, the first shield 800 includes a body 801 (which may be plate-shaped) and a plurality of ribs 810 extending from the body 801 along the vertical direction Z-Z.

Turning to FIGS. 9A, 9C, and 9E to 9F, the body 801 of the first shield 800 is disposed on the subassembly housing 700, and each rib 810 is received in a corresponding one of the plurality of openings 701 and is electrically coupled to a portion of the intermediate portion 203 of the corresponding ground terminal 200G exposed by the corresponding opening 701. With such a configuration, it is possible to provide shielding protection to the signal terminals 200S and reduce the crosstalk to improve signal integrity, thereby improving the signal transmission performance of the electrical connector 1. In particular, providing the body 801 of the first shield 800 on the subassembly housing 700 can provide shielding protection to the signal terminals 200S against external electromagnetic interference. Electrically coupling the body 801 to the plurality of ground terminals 200G through the ribs 810 can connect the electromagnetic interference absorbed by the body 801 to ground, and can reduce the effect of electrical resonance. In addition, as will be described in detail below, such configuration of the first terminal subassembly 300 can provide high-quality high-speed signal transmission without significantly increasing the footprint of the electrical connector 1.

In some embodiments, the first shield 800 may be formed from a metallic material such as copper or stainless steel. In this case, each rib 810 of the first shield 800 is in direct contact with the portion of the intermediate portion 203 of the corresponding ground terminal 200G exposed by the corresponding opening 701. For example, the ribs 810 of the first shield 800 may be attached to the ground terminals 200G by any suitable process, such as laser welding, to secure the first shield 800 to the subassembly housing 700. In this way, it is possible to omit other retaining mechanisms or features for securing the first shield 800 to the subassembly housing 700, thereby simplifying the manufacture and assembly of the first terminal subassembly 300, and facilitating reducing the size of the first terminal subassembly 300 in the vertical direction Z-Z.

It should be appreciated that in some other embodiments, the body 801 of the first shield 800 may be secured to the subassembly housing 700 by any suitable means, such as a snap fit, to bring the ribs 810 into direct contact with the ground terminals 200G.

In some other embodiments, the first shield 800 may be formed from a lossy material. In this case, each rib 810 of the first shield 800 may be in direct contact with or capacitively coupled with the portion of the intermediate portion 203 of the corresponding ground terminal 200G exposed by the corresponding opening 701. For example, the ribs 810 of the first shield 800 may be attached to the ground terminals 200G by any suitable process, such as laser welding, to retain the first shield 800 on the subassembly housing 700. As another example, the body 801 of the first shield 800 may be secured to the subassembly housing 700 by any suitable means, such as a snap fit, to bring the ribs 810 into direct contact or capacitive coupling with the ground terminals 200G.

Materials that dissipate a sufficient portion of the electromagnetic energy interacting with that material to appreciably impact the performance of a connector may be regarded as lossy. A meaningful impact results from attenuation over a frequency range of interest for a connector. In some configurations, lossy material may suppress resonances within ground structures of the connector and the frequency range of interest may include the natural frequency of the resonant structure, without the lossy material in place. In other configurations, the frequency range of interest may be all or part of the operating frequency range of the connector.

For testing whether a material is lossy, the material may be tested over a frequency range that may be smaller than or different from the frequency range of interest of the connector in which the material is used. For example, the test frequency range may extend from 10 GHz to 25 GHz or 1 GHz to 5 GHz. Alternatively, lossy material may be identified from measurements made at a single frequency, such as 10 GHz or 15 GHz.

Loss may result from interaction of an electric field component of electromagnetic energy with the material, in which case the material may be termed electrically lossy. Alternatively or additionally, loss may result from interaction of a magnetic field component of the electromagnetic energy with the material, in which case the material may be termed magnetically lossy.

Electrically lossy materials can be formed from lossy dielectric and/or poorly conductive materials. Electrically lossy material can be formed from material traditionally regarded as dielectric materials, such as those that have an electric loss tangent greater than approximately 0.01, greater than 0.05, or between 0.01 and 0.2 in the frequency range of interest. The “electric loss tangent” is the ratio of the imaginary part to the real part of the complex electrical permittivity of the material.

Electrically lossy materials can also be formed from materials that are generally thought of as conductors, but are relatively poor conductors over the frequency range of interest. These materials may conduct, but with some loss, over the frequency range of interest so that the material conducts more poorly than a conductor of an electrical connector, but better than an insulator used in the connector. Such materials may contain conductive particles or regions that are sufficiently dispersed that they do not provide high conductivity or otherwise are prepared with properties that lead to a relatively weak bulk conductivity compared to a good conductor such as pure copper over the frequency range of interest. Die cast metals or poorly conductive metal alloys, for example, may provide sufficient loss in some configurations.

Electrically lossy materials of this type typically have a bulk conductivity of about 1 Siemen/meter to about 100,000 Siemens/meter, or about 1 Siemen/meter to about 30,000 Siemens/meter, or 1 Siemen/meter to about 10,000 Siemens/meter. In some embodiments, material with a bulk conductivity of between about 1 Siemens/meter and about 500 Siemens/meter may be used. As a specific example, material with a conductivity between about 50 Siemens/meter and 300 Siemens/meter may be used. However, it should be appreciated that the conductivity of the material may be selected empirically or through electrical simulation using known simulation tools to determine a conductivity that provides suitable signal integrity (SI) characteristics in a connector. The measured or simulated SI characteristics may be, for example, low cross talk in combination with a low signal path attenuation or insertion loss, or a low insertion loss deviation as a function of frequency.

It should also be appreciated that a lossy member need not have uniform properties over its entire volume. A lossy member, for example, may have an insulative skin or a conductive core, for example. A member may be identified as lossy if its properties on average in the regions that interact with electromagnetic energy sufficiently attenuate the electromagnetic energy.

In some embodiments, lossy material is formed by adding to a binder a filler that contains particles. In such an embodiment, a lossy member may be formed by molding or otherwise shaping the binder with filler into a desired form. The lossy material may be molded over and/or through openings in conductors, which may be ground conductors or shields of the connector. Molding lossy material over or through openings in a conductor may ensure intimate contact between the lossy material and the conductor, which may reduce the possibility that the conductor will support a resonance at a frequency of interest. This intimate contact may, but need not, result in an Ohmic contact between the lossy material and the conductor.

Alternatively or additionally, the lossy material may be molded over or injected into insulative material, or vice versa, such as in a two shot molding operation. The lossy material may press against or be positioned sufficiently near a ground conductor that there is appreciable coupling to a ground conductor. Intimate contact is not a requirement for electrical coupling between lossy material and a conductor, as sufficient electrical coupling, such as capacitive coupling, between a lossy member and a conductor may yield the desired result. For example, in some scenarios, 100 pF of coupling between a lossy member and a ground conductor may provide an appreciable impact on the suppression of resonance in the ground conductor. In other examples with frequencies in the range of approximately 10 GHz or higher, a reduction in the amount of electromagnetic energy in a conductor may be provided by sufficient capacitive coupling between a lossy material and the conductor with a mutual capacitance of at least about 0.005 pF, such as in a range between about 0.01 pF to about 100 pF, between about 0.01 pF to about 10 pF, or between about 0.01 pF to about 1 pF. To determine whether lossy material is coupled to a conductor, coupling may be measured at a test frequency, such as 15 GHz or over a test range, such as 10 GHz to 25 GHz.

To form an electrically lossy material, the filler may be conductive particles. Examples of conductive particles that may be used as a filler to form an electrically lossy material include carbon or graphite formed as fibers, flakes, nanoparticles, or other types of particles. Various forms of fiber, in woven or non-woven form, coated or non-coated may be used. Non-woven carbon fiber is one suitable material. Metal in the form of powder, flakes, fibers or other particles may also be used to provide suitable electrically lossy properties. Alternatively, combinations of fillers may be used. For example, metal plated carbon particles may be used. Silver and nickel are suitable metal plating for fibers. Coated particles may be used alone or in combination with other fillers, such as carbon flake.

Preferably, the fillers will be present in a sufficient volume percentage to allow conducting paths to be created from particle to particle. For example, when metal fiber is used, the fiber may be present in about 3% to 30% by volume. The amount of filler may impact the conducting properties of the material, and the volume percentage of filler may be lower in this range to provide sufficient loss.

The binder or matrix may be any material that will set, cure, or can otherwise be used to position the filler material. In some embodiments, the binder may be a thermoplastic material traditionally used in the manufacture of electrical connectors to facilitate the molding of the electrically lossy material into the desired shapes and locations as part of the manufacture of the electrical connector. Examples of such materials include liquid crystal polymer (LCP) and nylon. However, many alternative forms of binder materials may be used. Curable materials, such as epoxies, may serve as a binder. Alternatively, materials such as thermosetting resins or adhesives may be used.

While the above-described binder materials may be used to create an electrically lossy material by forming a binder around conducting particle fillers, lossy materials may be formed with other binders or in other ways. In some examples, conducting particles may be impregnated into a formed matrix material or may be coated onto a formed matrix material, such as by applying a conductive coating to a plastic component or a metal component. As used herein, the term “binder” encompasses a material that encapsulates the filler, is impregnated with the filler or otherwise serves as a substrate to hold the filler.

Magnetically lossy material can be formed, for example, from materials traditionally regarded as ferromagnetic materials, such as those that have a magnetic loss tangent greater than approximately 0.05 in the frequency range of interest. The “magnetic loss tangent” is the ratio of the imaginary part to the real part of the complex electrical permeability of the material. Materials with higher loss tangents may also be used.

In some embodiments, a magnetically lossy material may be formed of a binder or matrix material filled with particles that provide that layer with magnetically lossy characteristics. The magnetically lossy particles may be in any convenient form, such as flakes or fibers. Ferrites are common magnetically lossy materials. Materials such as magnesium ferrite, nickel ferrite, lithium ferrite, yttrium garnet or aluminum garnet may be used. Ferrites will generally have a loss tangent above 0.1 at the frequency range of interest. Presently preferred ferrite materials have a loss tangent between approximately 0.1 and 1.0 over the frequency range of 1 GHz to 3 GHz and more preferably a magnetic loss tangent above 0.5 over that frequency range.

Practical magnetically lossy materials or mixtures containing magnetically lossy materials may also exhibit useful amounts of dielectric loss or conductive loss effects over portions of the frequency range of interest. Suitable materials may be formed by adding fillers that produce magnetic loss to a binder, similar to the way that electrically lossy materials may be formed, as described above.

It is possible that a material may simultaneously be a lossy dielectric or a lossy conductor and a magnetically lossy material. Such materials may be formed, for example, by using magnetically lossy fillers that are partially conductive or by using a combination of magnetically lossy and electrically lossy fillers.

Lossy portions may also be formed in a number of ways. In some examples the binder material, with fillers, may be molded into a desired shape and then set in that shape. In other examples the binder material may be formed into a sheet or other shape, from which a lossy member of a desired shape may be cut. In some embodiments, a lossy portion may be formed by interleaving layers of lossy and conductive material such as metal foil. These layers may be rigidly attached to one another, such as through the use of epoxy or other adhesive, or may be held collectively in any other suitable way. The layers may be of the desired shape before being secured to one another or may be stamped or otherwise shaped after they are held collectively. As a further alternative, lossy portions may be formed by plating plastic or other insulative material with a lossy coating, such as a diffuse metal coating.

Electrically coupling the plurality of ground terminals 200G together by the first shield 800 formed from the lossy material can reduce the effect of electrical resonance, thereby improving signal integrity. In particular, when the electrical resonance occurs at a frequency within the operating frequency range of the electrical connector 1, the integrity of the high-speed signal passing through the electrical connector 1 deteriorates. The deterioration in the integrity of the signal passing through the electrical connector 1 is partially caused by the loss of signal energy coupled into the resonant signal, which means that less signal energy passes through the electrical connector 1. The deterioration in the integrity of the signal passing through the electrical connector 1 is also partially caused by the coupling of the resonant signal from the ground terminals 200G to the signal terminals 200S. The resonant signal accumulates and possesses a high amplitude, so that when the resonant signal is coupled from the ground terminals 200G to the signal terminals 200S, it will generate a large amount of noise that interferes with the signal. Sometimes, the resonant signal coupled to the signal terminals 200S is referred to as crosstalk. As is known in the art, the frequency at which electrical resonance occurs is related to the length of the ground terminals supporting the electrical resonance, the reason is that the wavelength of the resonant signal is related to the length of the ground terminals supporting the resonance, and the frequency is inversely related to the wavelength. Electrically coupling the body 801 to the ground terminals 200G through the ribs 810 can enable energy coupled into the ground terminals 200G and accumulated into a resonant signal to be dissipated in the first shield 800, which reduces the possibility of the occurrence of electrical resonance, thereby increasing signal integrity and improving the operating frequency range of the electrical connector 1.

As shown in FIGS. 9E and 10A to 10D, each rib 810 of the first shield 800 includes a bottom portion 811, a first side portion 812, and a second side portion 813. The bottom portion 811 is electrically coupled to the aforementioned portion of the intermediate portion 203 of the corresponding ground terminal 200G and has a first end 811a and a second end 811b opposite to each other in the longitudinal direction Y-Y. The first side portion 812 and the second side portion 813 are opposed to each other in the longitudinal direction Y-Y and connect the first end 811a and the second end 811b of the bottom portion 811 to the body 801, respectively. With such a configuration of the rib 810, it is possible to provide two conductive paths between the body 801 of the first shield 800 and the aforementioned portion of the intermediate portion 203 of the corresponding ground terminal 200G, i.e., a first conductive path passing through the bottom portion 811 and the first side portion 812 and a second conductive path passing through the bottom portion 811 and the second side portion 813. This can improve the performance of the first shield 800 and thereby improve the signal transmission performance of the first terminal subassembly 300. Furthermore, with such a configuration of the rib 810, it is possible to enable the first shield 800 to provide a short conductive path between the two adjacent ground terminals 200G along the longitudinal direction Y-Y, i.e., from one of the two adjacent ground terminals 200G to the other of the two adjacent ground terminals 200G via the first conductive path of one rib 810, the body 801, and the second conductive path of another rib 810. This can also improve the performance of the first shield 800, thereby improving the signal transmission performance of the first terminal subassembly 300. In some embodiments, each rib 810 has a U-shaped profile. It should be appreciated that the present application is not limited thereto, and that each rib 810 may have any other non-planar profile.

In some embodiments, for each rib 810, the bottom portion 811 may be attached to the aforementioned portion of the intermediate portion 203 of the corresponding ground terminal 200G by any suitable process such as laser welding. In some other embodiments, for each rib 810, the bottom portion 811 may be positioned sufficiently close to the aforementioned portion of the intermediate portion 203 of the corresponding ground terminal 200G so as to be capacitively coupled with the same. In such embodiments, a gap exists between the rib 810 and the aforementioned portion of the intermediate portion 203 of the corresponding ground terminal 200G.

In some embodiments, as shown in FIGS. 9A to 9C, 9E, and 10A to 10D, the body 801 of the first shield 800 includes a plurality of openings 820. Each opening 820 is bounded by a first edge 821, a second edge 822, a third edge 823, and a fourth edge 824. The first edge 821 and the second edge 822 are opposed to each other in the longitudinal direction Y-Y, and the third edge 823 and the fourth edge 824 are opposed to each other in the lateral direction X-X. For example, the opposite ends of the first edge 821 are connected to a first end of the third edge 823 and a first end of the fourth edge 824, respectively, and the opposite ends of the second edge 822 are connected to a second end of the third edge 823 opposite to the first end and a second end of the fourth edge 824 opposite to the first end, respectively. For each rib 810, the first side portion 812 connects the first end 811a of the bottom portion 811 to the first edge 821 of a corresponding opening 820 of the body 801, and the second side portion 813 connects the second end 811b of the bottom portion 811 to the second edge 822 of the corresponding opening 820. Furthermore, for each rib 810, the bottom portion 811, the first side portion 812 and the second side portion 813 are not connected with the third edge 823 and the fourth edge 824 of the corresponding opening 820. With such a configuration, it is possible to enable the first shield 800 to provide a short conductive path between two adjacent ground terminals 200G in the longitudinal direction Y-Y. This can improve the performance of the first shield 800, thereby improving the signal transmission performance of the first terminal subassembly 300.

In some embodiments, each rib 810 of the first shield 800 is a portion stamped out from the body 801. In this case, the openings 820 may be formed when the ribs 810 are stamped out from the body 801. In some other embodiments, the first shield 800 may be formed by metal powder injection molding techniques.

In some embodiments, for each rib 810, the bottom portion 811 is in direct contact with the aforementioned portion of the intermediate portion 203 of the corresponding ground terminal 200G, and the direct contact is a surface contact. This surface contact can reduce the impedance at the connection site between the rib 810 and the ground terminal 200G, and mitigate or even eliminate the charge accumulation problem, thereby improving the signal transmission performance of the first terminal subassembly 300.

In some embodiments, as shown in FIGS. 9A to 9C, 9E, and 10A to 10D, each rib 810 of the first shield 800 is a U-shaped portion stamped out from the body 801 and includes a bottom (i.e., the aforementioned bottom portion 811), two end portions 815 and 816 opposite to each other in the longitudinal direction Y-Y, and two edges 817 and 818 opposite to each other in the lateral direction X-X. For each rib 810, the bottom is electrically coupled to the aforementioned portion of the intermediate portion 203 of the corresponding ground terminal 200G, the two end portions 815 and 816 are each connected to the body 801, and the two edges 817 and 818 are each disconnected from the body 801. When the rib 810 is stamped out from the body 801, the aforementioned openings 820 can be formed at the same time. With such a configuration of the rib 810, it is possible to provide two conductive paths between the body 801 and the aforementioned portion of the intermediate portion 203 of the corresponding ground terminal 200G, and it is possible to enable the first shield 800 to provide a short conductive path between the two adjacent ground terminals 200G in the longitudinal direction Y-Y. This can improve the performance of the first shield 800 and thus improve the signal transmission performance of the first terminal subassembly 300.

It should be appreciated that the rib 810 may have any other suitable configuration. For example, the rib 810 may be a tab stamped out from the body 801 and extending in a cantilevered manner.

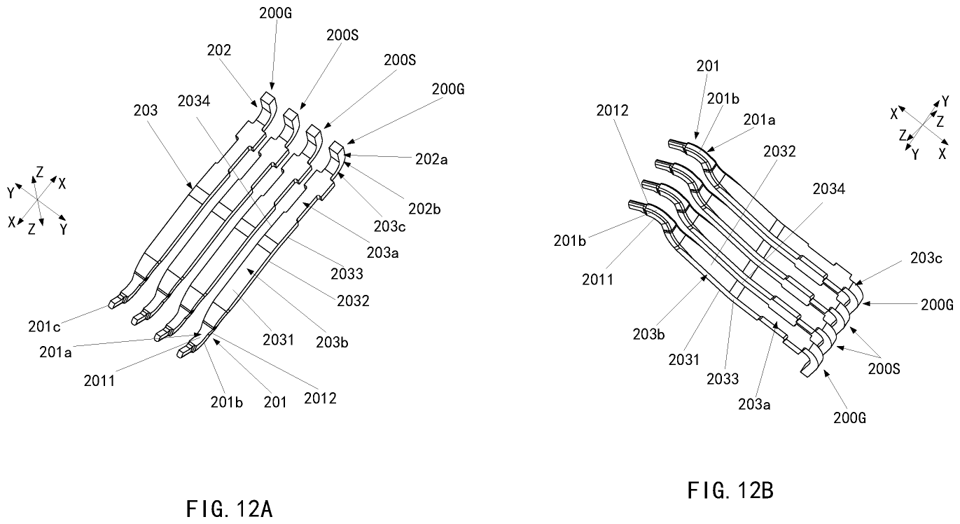

FIGS. 12A and 12B illustrate a group of four conductive elements of a plurality of conductive elements 200 of the first terminal subassembly 300 of FIG. 9C circled by the dashed frame “12a”. As shown in FIGS. 12A and 12B, the group of four conductive elements includes two ground terminals 200G and a pair of signal terminals 200S configured as a differential signal pair. The pair of signal terminals 200S is disposed between the two ground terminals 200G. For each conductive element 200, the intermediate portion 203 includes a first subportion 203a adjacent to the tail end 202 and a second subportion 203b adjacent to the mating end 201. In some embodiments, the second subportion 203b may connect the first subportion 203a to the mating end 201. In some other embodiments, the first subportion 203a and the second subportion 203b may have other subportion(s) therebetween, and/or the second subportion 203b and the mating end 201 may have other subportion(s) therebetween.

In some embodiments, as shown in FIGS. 12A and 12B, for each conductive element 200, the intermediate portion 203 may also include a third subportion 203c extending in the lateral direction X-X from the first subportion 203a and extending outside the subassembly housing 700 to connect to the tail end 202. In one of these embodiments, the tail end 202 includes a straight portion 202a and a curved portion 202b. The curved portion 202b extends between the straight portion 202a and the third subportion 203c of the intermediate portion 203 and is curved towards the body 801 of the first shield 800 so that the straight portion 202a and the third subportion 203c are oriented to be perpendicular to each other. For example, the straight portion 202a of the tail end 202 is oriented in the vertical direction Z-Z. The straight portion 202a may be configured to be soldered to a conductive pad of the aforementioned circuit board. It should be appreciated that in some other embodiments, the tail end 202 may be in any other suitable form, such as a press-fit “needle eye”. It should also be appreciated that in some other embodiments, the tail end 202 may be curved away from the body 801 of the first shield 800 so that the straight portion 202a and the third subportion 203c are oriented to be perpendicular to each other, or the tail end 202 may be devoid of the curved portion 202b.

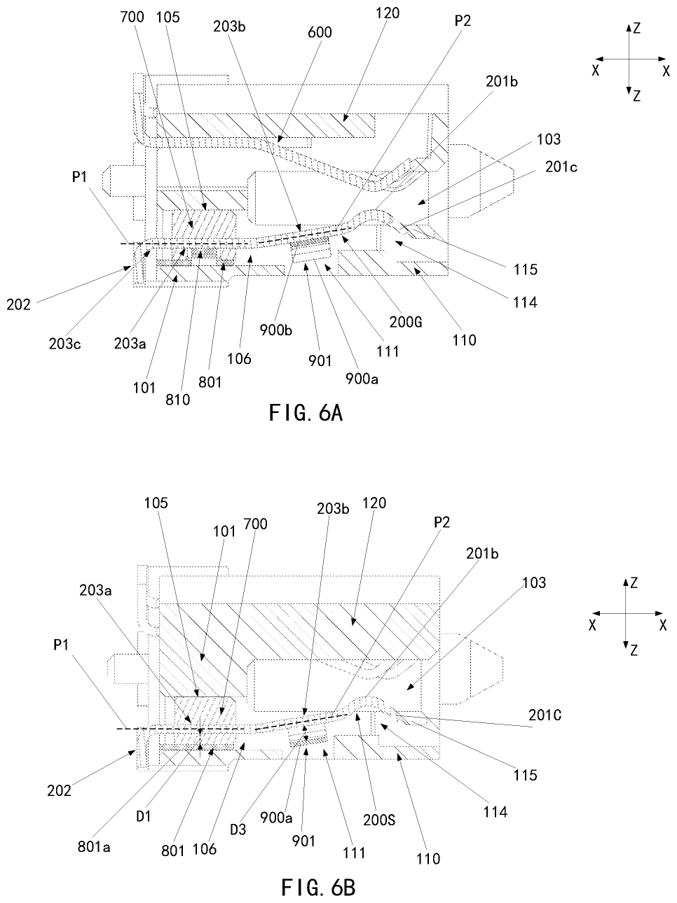

In some embodiments, with reference to FIGS. 6A to 6B and 9A to 9F, the subassembly housing 700 is disposed around the first subportions 203a of the intermediate portions 203 of the plurality of conductive elements 200 to retain the plurality of conductive elements 200, so that the first subportions 203a are oriented in the lateral direction X-X and are aligned with each other in the longitudinal direction Y-Y. The first subportions 203a may extend in a first plane P1 perpendicular to the vertical direction Z-Z (FIGS. 6A and 6B). For example, the first plane P1 is parallel to the lateral direction X-X and the longitudinal direction Y-Y. Each of the plurality of openings 701 of the subassembly housing 700 exposes at least a portion of the first subportion 203a of the intermediate portion 203 of a corresponding one of the plurality of ground terminals 200G. For example, each opening 701 may expose 10%, 20%, 30%, 50%, 70%, 90%, 100% of the length, or any other suitable length of the first subportion 203a of the intermediate portion 203 of the corresponding ground terminal 200G in the lateral direction X-X. As another example, each opening 701 may expose all or a portion of the width of the first subportion 203a of the intermediate portion 203 of the corresponding ground terminal 200G in the longitudinal direction Y-Y. The body 801 of the first shield 800 is oriented to be parallel to the first plane P1. Each of the plurality of ribs 810 of the first shield 800 is received in a corresponding one of the plurality of openings 701 and is electrically coupled to at least the portion of the first subportion 203a of the intermediate portion 203 of the corresponding ground terminal 200G exposed by the corresponding opening 701.

As shown in FIGS. 6A to 7B, 9A, 9C, 9D, and 9F, the second subportions 203b of the intermediate portions 203 and the mating ends 201 of the plurality of conductive elements 200 can be extended in a cantilevered manner to enable the second subportions 203b and the mating ends 201 to be resiliently deflected relative to the first subportions 203a. Such a configuration can provide a mating force for mating with a corresponding conductive portion of the aforementioned plug connector.

As shown in FIG. 9B, the subassembly housing 700 includes a flat first face 703 extending parallelly to the first plane P1. The plurality of openings 701 are recessed into the subassembly housing 700 from the first face 703 along the vertical direction Z-Z. As shown in FIGS. 10A and 10B, the body 801 of the first shield 800 includes a flat second face 801a. The plurality of ribs 810 protrude from the second face 801a. As illustrated in FIG. 9E, the body 801 of the first shield 800 is disposed on the subassembly housing 700 so that the second face 801a of the body 801 is placed on the first face 703 of the subassembly housing 700 and each rib 810 is received in a corresponding one of the plurality of openings 701. With such a configuration, it is possible to minimize the size of the first terminal subassembly 300 in the vertical direction Z-Z, thereby enabling the first terminal subassembly 300 to provide high-quality high-speed signal transmission without significantly increasing the size of the electrical connector 1 in the vertical direction Z-Z.

As shown in FIGS. 6B and 9E, the first subportion 203a of the intermediate portion 203 of the signal terminal 200S is spaced from the body 801 of the first shield 800 by a first distance D1 in the vertical direction Z-Z. The center of the first subportion 203a of the intermediate portion 203 of the signal terminal 200S is spaced from an edge of the first subportion 203a of the intermediate portion 203 of a corresponding adjacent ground terminal 200G by a second distance D2 in the longitudinal direction Y-Y. The first distance D1 may be less than or equal to the second distance D2. With such a configuration, the body 801 of the first shield 800 may act as the closest ground reference for the signal terminal 200S. In some embodiments, the first distance D1 may be equal to the second distance D2 so that the signal terminal 200S is shielded in a manner similar to the manner in which a wire with coaxial or biaxial cables is shielded.

In some embodiments, as shown in FIGS. 6B and 9E, the first subportion 203a of the intermediate portion 203 of the signal terminal 200S may be separated from the body 801 of the first shield 800 by the subassembly housing 700 in the vertical direction Z-Z.

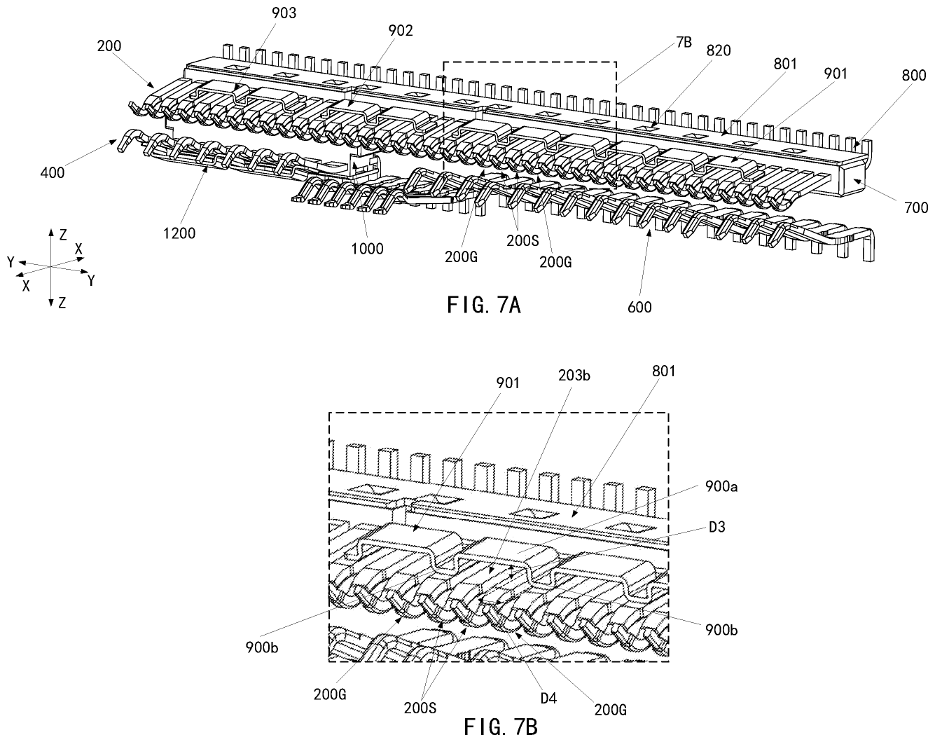

In some embodiments, as illustrated in FIGS. 7A, 9A, and 9C to 9D, the extended range of the body 801 of the first shield 800 in the longitudinal direction Y-Y may cover at least the first subportions 203a of the intermediate portions 203 of the signal terminals 200S and the plurality of ground terminals 200G.

In some embodiments, as illustrated in FIGS. 6A and 6B, the extended range of the body 801 of the first shield 800 in the lateral direction X-X may cover at least the first subportion 203a of the intermediate portion 203 of each of the signal terminals 200S and the plurality of ground terminals 200G. In one of these embodiments, the body 801 of the first shield 800 extends beyond the edge 705 of the subassembly housing 700 in the lateral direction X-X so that the body 801 of the first shield 800 also covers the third subportion 203c of the intermediate portion 203 of each of the signal terminals 200S and the plurality of ground terminals 200G. With such a configuration, it is possible to provide shielding substantially along the first subportion 203a and the third subportion 203c of the signal terminal 200S. This enables to improve the signal transmission performance of the first terminal subassembly 300.

It should be appreciated that although the body 801 of the first shield 800 is shown as a single integral piece, in some other embodiments, the body 801 of the first shield 800 may also be formed as a discrete plurality of pieces each including several ribs. In one of these embodiments, the discrete plurality of pieces may be connected together by a conductive structure such as a wire or a conductive element.

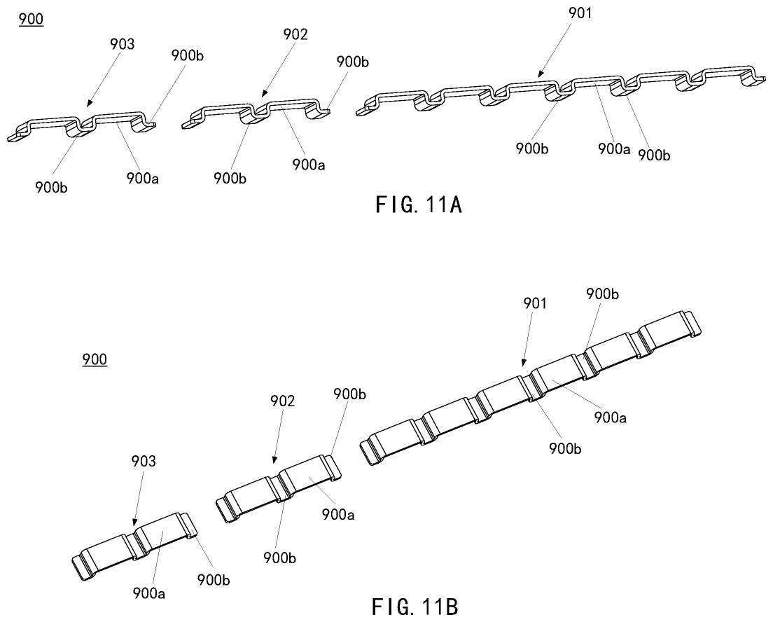

The second shield 900 includes at least one shield. In some embodiments, as shown in FIGS. 9A to 9C and 11A to 11B, the second shield 900 includes three shields 901, 902, and 903. It should be appreciated that in some other embodiments, the second shield 900 may include one, two, or more than three shields. It should also be appreciated that several shields of the second shield 900 may be connected together by a conductive structure such as a wire or a conductive element. Each of the shields 901, 902, and 903 includes a plateau 900a and a valley 900b, with each plateau 900a extending between two corresponding adjacent valleys 900b of the valleys 900b. For each of shields 901, 902, and 903, each valley 900b is attached on at least a portion of the second subportion 203b of the intermediate portion 203 of a corresponding one of the plurality of ground terminals 200G, so that the plateau 900a extending between the corresponding two adjacent valleys 900b is positioned above the second subportion 203 of the intermediate portion 203 of the corresponding at least one signal terminal 200S, wherein the corresponding at least one signal terminal 200S is positioned between the two adjacent ground terminals 200G corresponding to the two adjacent valleys 900b.

With such a configuration, it is possible to provide shielding protection to the signal terminals 200S and reduce the crosstalk to improve signal integrity, thereby improving the signal transmission performance of the electrical connector 1. In particular, the second shield 900 can provide shielding protection to the signal terminals 200S against external electromagnetic interference. By attaching the valleys 900b on the ground terminals 200G, it is possible to connect the plurality of ground terminals 200G together by the second shield 900, which enables the electromagnetic interference absorbed by the second shield 900 to be connected to ground and reduces the effect of electrical resonance. Furthermore, as will be described in detail below, this configuration of the first terminal subassembly 300 can provide high-quality high-speed signal transmission without significantly increasing the footprint of the electrical connector 1.

In some embodiments, the shields 901, 902, and 903 may be formed from a metallic material such as copper or stainless steel. In some other embodiments, the shields 901, 902, and 903 may be formed from a lossy material.

As shown in FIGS. 6A to 7B, 9A to 9D, and 9F, the second subportions 203b of the intermediate portions 203 of the plurality of conductive elements 200 are aligned with each other in the longitudinal direction Y-Y and may extend in a second plane P2 (FIGS. 6A and 6B) parallel to the longitudinal direction Y-Y. In some embodiments, the second plane P2 may be inclined relative to the first plane P1. For each of the shields 901, 902, and 903, each plateau 900a is oriented to be parallel to the second plane P2.

As shown in FIGS. 6B and 7B, the second subportion 203b of the intermediate portion 203 of the signal terminal 200S is spaced from the corresponding plateau 900a in a direction perpendicular to the second plane P2 by a third distance D3. The center of the second subportion 203b of the intermediate portion 203 of the signal terminal 200S is spaced from an edge of the second subportion 203 of the intermediate portion 203 of a corresponding adjacent ground terminal 200G in the longitudinal direction Y-Y by a fourth distance D4. The third distance D3 may be less than or equal to the fourth distance D4. With such a configuration, the plateau 900a of the second shield 900 may act as the closest ground reference for the signal terminal 200S. In some embodiments, the third distance D3 may be equal to the fourth distance D4 so that the signal terminal 200S is shielded in a manner similar to the manner in which a wire with coaxial or biaxial cables is shielded. In some embodiments, the third distance D3 may be equal to the aforementioned first distance D1.

In some embodiments, as illustrated in FIGS. 7A, 9A, and 9C to 9D, the extended range of the second shield 900 in the longitudinal direction Y-Y may cover the second subportions 203b of the intermediate portions 203 of the signal terminals 200S and the plurality of ground terminals 200G.

In some embodiments, as illustrated in FIGS. 6A and 6B, each plateau 900a of the second shield 900 may cover, in a direction perpendicular to the second plane P2, 10%, 20%, 30%, 50%, 70%, 90%, 100% of the length, or any other suitable length of the second subportion 203b of the intermediate portion 203 of each of the corresponding at least one of the signal terminals 200S.

As shown in FIGS. 12A and 12B, for each conductive element 200, the intermediate portion 203 includes a first broadside 2031 and a second broadside 2032 opposite to each other and a first edge 2033 and a second edge 2034 opposite to each other. The first edge 2033 and the second edge 2034 each connect the first broadside 2031 with the second broadside 2032. As shown in FIGS. 6A to 7B and 9A to 9F, for the first shield 800, each rib 810 is electrically coupled to at least a portion of the first subportion 203a of the intermediate portion 203 of the corresponding ground terminal 200G on the first broadside 2031 of the intermediate portion 203, and for the second shield 900, each valley 900b of each shield is attached to at least a portion of the second subportion 203b of the intermediate portion 203 of the corresponding ground terminal 200G on the first broadside 2031 of the intermediate portion 203. For example, the first shield 800 and the second shield 900 are located on the same side of the conductive elements 200.

As shown in FIGS. 12A and 12B, for each conductive element 200, the mating end 201 includes a third broadside 2011 and a fourth broadside 2012 opposite to each other. The third broadside 2011 of the mating end 201 is connected to the first broadside 2031 of the intermediate portion 203, and the fourth broadside 2012 of the mating end 201 is connected to the second broadside 2032 of the intermediate portion 203. The mating end 201 also includes a mating contact portion 201a comprising a mating contact surface 201b on the fourth broadside 2012. For example, in the case where the first terminal subassembly 300 is configured to be used in a receptacle connector, the first shield 800 and the second shield 900 may be disposed on a side of the conductive elements 200 opposite to the mating contact surfaces 201b of the mating ends 201. Accordingly, as will be described in detail below, the first shield 800 and the second shield 900 may be disposed on a side of the conductive elements 200 opposite to the slot 103. It should be appreciated that the present application is not limited thereto.

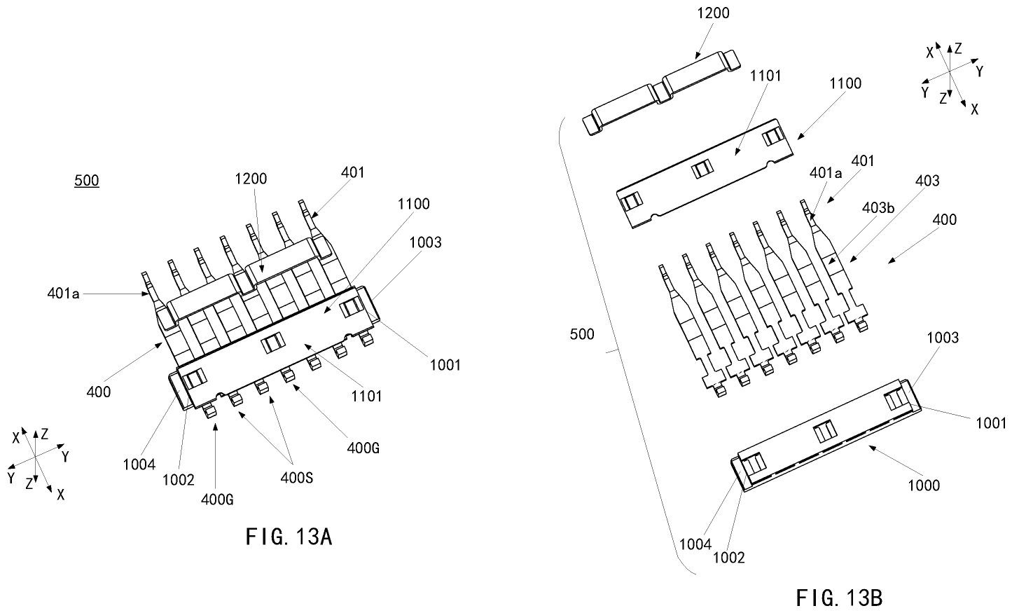

As shown in FIGS. 3, 13A, and 13B, the second terminal subassembly 500 includes a plurality of conductive elements 400, a subassembly housing 1000, a third shield 1100, and a fourth shield 1200. The plurality of conductive elements 400 includes a signal terminal 400S and a plurality of ground terminals 400G. The configuration of the second terminal subassembly 500 may be substantially similar to the configuration of the first terminal subassembly 300. In particular, the configurations of the conductive elements 400, the subassembly housing 1000, the third shield 1100, and the fourth shield 1200 of the second terminal subassembly 500 may be substantially similar to the configurations of the conductive elements 200, the subassembly housing 700, the first shield 800, and the second shield 900 of the first terminal subassembly 300, respectively. Thus, portions that are identical between them may not be labeled in the drawings and/or be repeated herein.

It should be appreciated that although the body 1101 of the third shield 1100 is shown as a single integral piece, in some other embodiments, the body 1101 of the third shield 1100 may also be formed as a discrete plurality of pieces each including several ribs. In one of these embodiments, the discrete plurality of pieces may be connected together by a conductive structure such as a wire or a conductive element.

In addition, it should be appreciated that although the fourth shield 1200 is shown as a single shield, in some other embodiments, the fourth shield 1200 may include two or more shields. In one of these embodiments, several shields of the fourth shield 1200 may be connected together by a conductive structure such as a wire or a conductive element.

As shown in FIGS. 13A and 13B, the subassembly housing 1000 includes a first end face 1001 and a second end face 1002 opposite to each other in the longitudinal direction Y-Y. The subassembly housing 1000 of the second terminal subassembly 500 differs from the subassembly housing 700 of the first terminal subassembly 300 in that the subassembly housing 1000 includes a first tab 1003 extending from the first end face 1001 along the longitudinal direction Y-Y and a second tab 1004 extending from the second end face 1002 along the longitudinal direction Y-Y. The specific function of this structure of the subassembly housing 1000 will be described below in connection with the configuration of the housing 100.

As shown in FIGS. 3, 13A, and 13B, the configuration of the conductive element 600 may be substantially similar to the configuration of the conductive element 200 of the first terminal subassembly 300. Thus, portions that are identical between them are not labeled in the drawings and will not be repeated herein. Unlike the conductive elements 200 of the first terminal subassembly 300, a plurality of conductive elements 600 are inserted directly in the housing 100. For example, the conductive elements 600 may be configured as power terminals for transmitting electrical power.

Turning to FIGS. 1 to 6B and 8A to 8D, the housing 100 also includes: a first space 105 recessed into the body 101 along the lateral direction X-X from a second side of the body 101 opposite to the aforementioned first side; a second space 106 recessed into the first wall 110 along the vertical direction Z-Z from the slot 103 and extending along the lateral direction X-X to communicate with the first space 106; a third space 107 recessed into the body 101 along the lateral direction X-X from the second side of the body 101; and a fourth space 108 recessed into the second wall 120 along the vertical direction Z-Z from the slot 103 and extending along the lateral direction X-X to communicate with the third space 107. The first space 105 and the third space 107 are recessed into the body 101 along the lateral direction X-X from the mounting face 101a of the body 101 (which may also be referred to as “a mounting surface” of the housing 100). For example, the housing 100 may include a first space 105 and a third space 107 recessed into the housing 100 from the mounting face 101a along the lateral direction X-X, respectively.

As shown in FIGS. 1 to 6B, the subassembly housing 700 and the first shield 800 of the first terminal subassembly 300 are held in the first space 105 by the housing 100 so that the second subportions 203b of the intermediate portions 203 of the plurality of conductive elements 200 and the second shield 900 (shown as shields 901, 902, and 903) are disposed in the second space 106, and so that the mating contact portions 201 of the mating ends 201 of the plurality of conductive elements 200 are exposed in the slot 103 for mating with the corresponding conductive portions of the aforementioned plug connector. With such a configuration, the first shield 800 and the second shield 900 of the first terminal subassembly 300 are disposed within the boundary of the housing 100, and thus the first shield 800 and the second shield 900 do not additionally increase the size of the electrical connector 1 in the vertical direction Z-Z, which facilitates the miniaturization of the electrical connector 1. In addition, the first terminal subassembly 300 enables to omit the channels, formed in the housing of the conventional electrical connector, for holding the intermediate portions of the conductive elements. This can improve the manufacturing and assembly efficiency of the electrical connector, and reduce the manufacturing cost.

As shown in FIGS. 1 to 6B, the first shield 800 and the second shield 900 may be disposed on a side of the conductive element 200 opposite to the slot 103. In some embodiments, the first wall 110 of the housing 100 may include at least one opening each extending along the vertical direction Z-Z to expose a corresponding one of the at least one shield of the second shield 900 of the first terminal subassembly 300. As shown in FIGS. 3, 4, 5D, 6A, 6B, and 8B, the first wall 110 of the housing 100 may include three openings 111, 112, and 113 each extending along the vertical direction Z-Z to expose a corresponding one of the three shields 901, 902, and 903 of the second shield 900. This configuration can further improve the high-speed signal transmission performance of the electrical connector 1. As previously described, the second subportions 203b of the intermediate portions 203 and mating ends 201 of the plurality of conductive elements 200 may extend in a cantilevered manner. Each of the three openings 111, 112, and 113 may be configured so that when the second subportions 203b of the ground terminals 200G are deflected away from the slot 103 in the vertical direction Z-Z, the corresponding shield can be moved into the opening without interfering with the first wall 110. With such a configuration, the dimension of the electrical connector 1 in the vertical direction Z-Z can be further optimized.

The aforementioned configurations of the first terminal subassembly 300 and the insulative housing 100 can provide high-quality high-speed signal transmission without significantly increasing the size of the electrical connector 1 in the vertical direction Z-Z. This is important for deploying the electrical connector 1 in a space-constrained electronic system. For example, this enables the electrical connector 1 to comply with the form factor requirements set forth in existing standards such as SSF-8639, while providing high-quality high speed signal transmission.

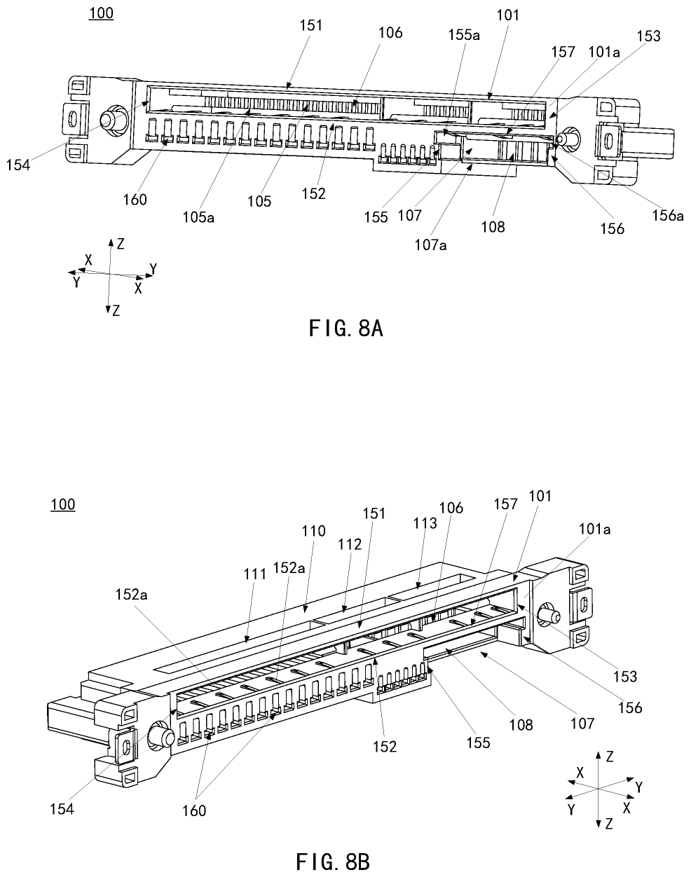

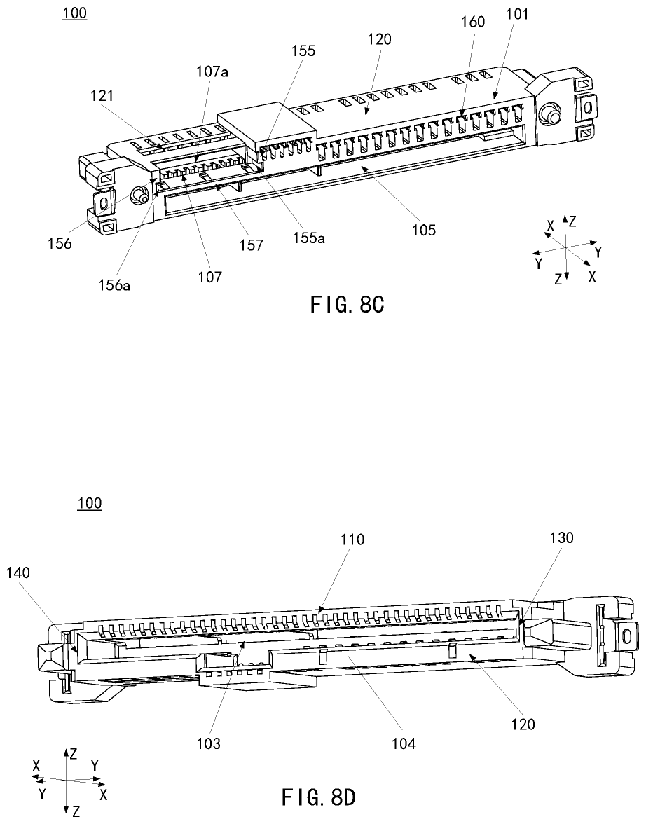

In some embodiments, as shown in FIGS. 6A, 6B, and 8A, the first wall 110 includes a plurality of channels 114 and a plurality of shelves 115. Each of the plurality of channels 114 extends from the second space 106 into the first wall 110 along the lateral direction X-X, and each of the plurality of shelves 115 separates a corresponding one of the plurality of channels 114 from the slot 103 in the vertical direction Z-Z. For each conductive element 200, a tip 201c of the mating end 201 is received in a corresponding one of the plurality of channels 114 and is limited by a corresponding one of the plurality of shelves 115 to be prevented from moving into the slot 103. With such a configuration, it is possible to keep the mating ends 201 of the conductive elements 200 in place to prevent interference with the corresponding conductive portion of the aforementioned plug connector when it is inserted into the slot 103.

In some embodiments, as shown in FIGS. 8A to 8C, the body 101 of the housing 100 includes a first section wall 151, a second section wall 152, a third section wall 153, and a fourth section wall 154, bounding the first space 105. The first section wall 151 and the second section wall 152 are opposite to each other in the longitudinal direction Y-Y, and the third section wall 153 and the fourth section wall 154 are opposite to each other in the vertical direction Z-Z. The subassembly housing 700 and the first shield 800 of the first terminal subassembly 300 are configured to be inserted into the first space 105 along the lateral direction X-X from the entrance 105a of the first space 105 and to be held in the first space 105 by engaging with the first section walls 151, the second section walls 152, the third section walls 153, and the fourth section walls 154. With such a configuration, the subassembly housing 700 and the first shield 800 are reliably retained in the first space 105 and can seal the first space 105 to prevent contaminants from entering the slot 103 via the first space 105.

In one of these embodiments, at least one of the first section wall 151, the second section wall 152, the third section wall 153, and the fourth section wall 154 includes a bump. The bump protrudes into the first space 105 and extends along the lateral direction X-X. The height of the bump gradually increases as the bump extends along the lateral direction X-X away from the entrance 105a of the first space 105. As illustrated in FIG. 8B, the second section wall 152 includes a plurality of bumps 152a. The bumps 152a may be wedge-shaped. When the subassembly housing 700 and the first shield 800 of the first terminal subassembly 300 are inserted into the first space 105, the plurality of bumps 152a engage with the subassembly housing 700 so that the subassembly housing 700 and the first shield 800 are sandwiched between the first section wall 151 and the second section wall 152 to limit movement of the subassembly housing 700 and the first shield 800 relative to the housing 100 along the lateral direction X-X, the longitudinal direction Y-Y, and the vertical direction Z-Z. The third section wall 153 and the fourth section wall 154 may engage with the subassembly housing 700 in the longitudinal direction Y-Y, thereby further restricting the subassembly housing 700 and the first shield 800 from moving relative to the housing 100 along the longitudinal direction Y-Y. It should be appreciated that the subassembly housing 700 and the first shield 800 of the first terminal subassembly 300 may be retained in the first space 105 by any other suitable mechanism or feature.

Similar to the first terminal subassembly 300, as shown in FIGS. 1 to 6B, the subassembly housing 1000 and the third shield 1100 of the second terminal subassembly 500 are retained in the third space 107 by the housing 100 so that the second subportions 403b of the intermediate portions 403 of the plurality of conductive elements 400 (FIGS. 13A and 13B) and the fourth shield 1200 (which is shown as a shield) are disposed in the fourth space 108 and so that the mating contact portions 401a of the mating ends 401 of the plurality of conductive elements 400 are exposed in the slot 103 for mating with the corresponding conductive portions of the aforementioned plug connector. With such a configuration, the third shield 1100 and the fourth shield 1200 of the second terminal subassembly 500 are disposed within the boundary of the housing 100, and thus the third shield 1100 and the fourth shield 1200 do not additionally increase the dimension of the electrical connector 1 in the vertical direction Z-Z, which facilitates the miniaturization of the electrical connector 1. In addition, the second terminal subassembly 500 enables to omit the channels, formed in the housing of a conventional electrical connector, for holding the intermediate portions of the conductive elements. This can increase the efficiency of manufacturing and assembly of the electrical connector, and reduce the manufacturing cost.

Similar to the first wall 110, the second wall 120 may include an opening 121. The opening 121 extends along the vertical direction Z-Z to expose the fourth shield 1200. In some embodiments, the opening 121 may be configured so that when the second subportions 403b of the ground terminals 400G of the plurality of conductive elements 400 are deflected away from the slot 103 along the vertical direction Z-Z, the fourth shield 1200 can be moved into the opening 121 without interfering with the second wall 120. With such a configuration, the dimension of the electrical connector 1 in the vertical direction Z-Z can be further optimized.

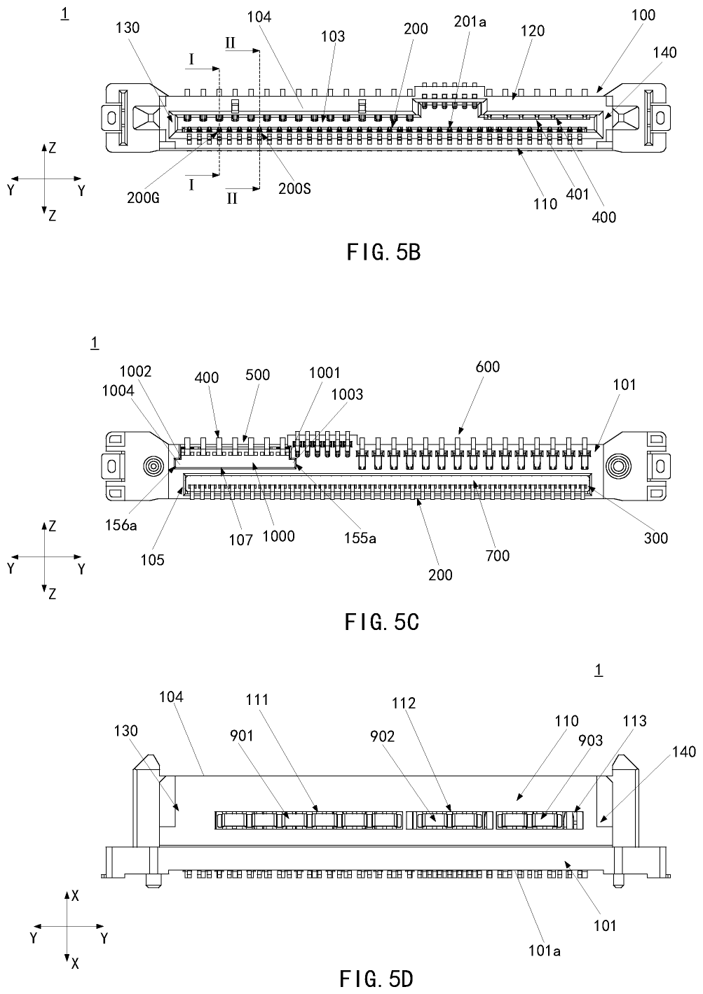

As shown in FIGS. 8A to 8C, unlike the first space 105, the third space 107 may be bounded by the fifth section wall 155, the sixth section wall 156, and the seventh section wall 157 of the body 101 of the housing 100. In particular, the fifth section wall 155 and the sixth section wall 156 are opposite to each other in the longitudinal direction Y-Y, and the seventh section wall 157 may bound the third space 107 in the vertical direction Z-Z. The third space 107 extends from the seventh section wall 157 through the housing 100 along the vertical direction Z-Z to form an open portion 107a. For example, the housing 100 includes a fifth section wall 155 and a sixth section wall 156 opposite to each other in the longitudinal direction Y-Y and bounding the third space 107 in the longitudinal direction Y-Y, and a seventh section wall 157 bounding the third space 107 in the vertical direction Z-Z, and the third space 107 extends from the seventh section wall 157 through the housing 100 along the vertical direction Z-Z to form the open portion 107a. As shown in FIG. 5A, the body 1101 of the third shield 1100 of the second terminal subassembly 500 may be exposed through the open portion 107a. This configuration can further improve the high-speed signal transmission performance of the electrical connector 1. It should be appreciated that in some embodiments, the first wall 110 and the first shield 800 may be similarly configured.

In some embodiments, as shown in FIGS. 5C and 8A to 8C, the body 101 of the housing 100 may include a first groove 155a recessed into the fifth section wall 155 along the longitudinal direction Y-Y and a second groove 156a recessed into the sixth section wall 156 along the longitudinal direction Y-Y. As shown in FIGS. 5C and 13A to 13B and as described above, the subassembly housing 1000 includes a first tab 1003 extending from a first end face 1001 in the longitudinal direction Y-Y and a second tab 1004 extending from a second end face 1002 in the longitudinal direction Y-Y. As illustrated in FIG. 5C, when the subassembly housing 1000 is disposed in the first space 105, the first tab 1003 and the second tab 1004 of the subassembly housing 1000 may engage with the first groove 155a and the second groove 156a of the housing 100, respectively, to limit the movement of the subassembly housing 700 relative to the housing 100 along the vertical direction Z-Z and the longitudinal direction Y-Y. In addition, similar to the first section wall 151, the second section wall 152, the third section wall 153, and the fourth section wall 154, at least one of the fifth section wall 155, the sixth section wall 156, and the seventh section wall 157 may include a bump to help to retain the subassembly housing 1000 and the third shield 1100 in the third space 107.

As shown in FIGS. 8A to 8C, the housing 100 may include a plurality of channels 160 configured for placing the plurality of conductive elements 600. Each of the plurality of conductive elements 600 may be inserted in a corresponding one of the plurality of channels 160. It should be appreciated that the present application is not limited thereto.

Although the configuration of the electrical connector 1 is described in detail above in connection with the embodiments of the first terminal subassembly 300 and the second terminal subassembly 500, it should be appreciated that the electrical connector 1 may have only one terminal subassembly, or may have more terminal assemblies, which may have a similar configuration to those of the first terminal subassembly 300 and the second terminal subassembly 500.

Although the configuration of the first terminal subassembly 300 is described in detail above in connection with the embodiments of the first terminal subassembly 300 having the first shield 800 and the second shield 900, it should be appreciated that the first terminal subassembly 300 may have only one of the first shield 800 and the second shield 900, or the first terminal subassembly 300 may have an additional shield. For example, there may be another shield on a side of the subassembly housing 700 opposite to the first shield 800, which may be similar in configuration to the first shield 800. In the case where the first terminal subassembly 300 does not have the first shield 800, the subassembly housing 700 may be held in the first space 105 by the housing 100 by engaging with the section walls. In addition, it should be appreciated that the first shield 800 and the second shield 900 may be electrically coupled to a ground conductor in any other suitable manner.

Although the configuration of the second terminal subassembly 500 is described in detail above in connection with the embodiments of the second terminal subassembly 500 having the third shield 1100 and the fourth shield 1200, it should be appreciated that the second terminal subassembly 500 may have only one of the third shield 1100 and the fourth shield 120, or the second terminal subassembly 500 may have an additional shield. For example, there may be another shield on a side of the subassembly housing 1000 opposite to the third shield 1100, which may be similar in configuration to the third shield 1100. In the case where the second terminal subassembly 500 does not have the third shield 1100, the subassembly housing 1000 may be held in the third space 107 by the housing 100 by engaging with the section walls. In addition, it should be appreciated that the third shield 1100 and the fourth shield 1200 can be electrically coupled to a ground conductor in any other suitable manner.

Although the configuration of the first terminal subassembly 300 is described in detail above in connection with the embodiments in which the first shield 800 is electrically coupled to at least a portion of the first subportion 203a of the intermediate portion 203 of the ground terminal 200G and the second shield 900 is attached to at least a portion of the second subportion 203b of the intermediate portion 203 of the ground terminal 200G, it should be appreciated that the first shield 800 and the second shield 900 may be disposed in varying positions. For example, the first shield 800 may be electrically coupled to at least a portion of the second subportion 203b of the intermediate portion 203 of the ground terminal 200G. For another example, the second shield 900 may be attached on at least a portion of the first subportion 203a of the intermediate portion 203 of the ground terminal 200G. The subassembly housing 700 and the housing 100 may be varied accordingly. Furthermore, it should be appreciated that similar to the first shield 800 and the second shield 900, the third shield 1100 and the fourth shield 1200 may be disposed in varying positions.

It should be appreciated that the first terminal subassembly 300 and/or the second terminal subassembly 500 may be used for any other suitable type of connector, such as, a card edge connector and a plug connector. For example, in the case where the first terminal subassembly 300 and the second terminal subassembly 500 are used in a plug connector, the positions of the second shield 900 and the fourth shield 1200 may be changed accordingly.

Although details of specific configuration of the electrical connector 1 are described above, it should be appreciated that such details are provided solely for purposes of illustration, as the concepts disclosed herein are capable to be implemented in other manners. In that respect, the electrical connector 1 described herein may be used in any suitable combination, as aspects of the present disclosure are not limited to the particular combinations shown in the drawings.

It should also be appreciated that the terms “first”, “second”, “third”, “fourth”, “fifth”, “sixth”, and “seventh” are only used to distinguish an element, component or portion from another element, component or portion, and that these elements, components or portions should not be limited by such terms.

The present application has been described in detail in conjunction with specific embodiments. Obviously, the above description and the embodiments shown in the appended drawings should be understood to be exemplary and do not constitute any limitations to the present application. For a person skilled in the art, various variations or modifications can be made without departing from the spirit of the present application, and these variations or modifications shall fall within the scope of the present application.

What is claimed is:

1. A connector subassembly comprising:
a plurality of conductive elements each comprising a mating end, a tail end opposite to the mating end, and an intermediate portion extending between the mating end and the tail end;
a subassembly housing holding the plurality of conductive elements in a row and comprising a plurality of openings aligned with portions of the intermediate portions of selected ones of the plurality of conductive elements; and
a shield comprising a body disposed on the subassembly housing and a plurality of ribs each extending from the body into a respective opening of the plurality of openings of the subassembly housing.

2. The connector subassembly of claim 1, wherein:
the shield is coupled to the selected ones of the plurality of conductive elements through the plurality of ribs extend into the plurality of openings of the subassembly housing.

3. The connector subassembly of claim 1, wherein:
the body of the shield comprises a plurality of openings each aligned with a respective opening of the plurality of openings of the subassembly housing; and
each rib of the plurality of ribs of the shield extends from edges of a respective opening of the plurality of openings of the body of the shield.

4. The connector subassembly of claim 1, wherein:
the body of the shield extends beyond the subassembly housing toward the tail ends of the plurality of conductive elements.

5. The connector subassembly of claim 1, wherein:
for each of the plurality of conductive elements, the intermediate portion comprises a first subportion and a second subportion disposed closer to the mating end than the first subportion;
the first subportions of the intermediate portions of the plurality of conductive elements are embedded in the subassembly housing; and
each of the plurality of ribs extends toward a portion of the first subportion of the intermediate portion of a respective one of the selected ones of the plurality of conductive elements.

6. The connector subassembly of claim 5, wherein:
the plurality of conductive elements comprise conductive elements configured for signal disposed between the selected ones configured for ground; and
for each of the signal conductive elements:
the first subportion of the intermediate portion is spaced from the body of the shield by a first distance;
a center of the first subportion of the intermediate portion is spaced from an edge of the first subportion of the intermediate portion of an adjacent ground conductive element by a second distance; and
the first distance is less than or equal to the second distance.

7. The connector subassembly of claim 6, wherein:
the first subportion of the intermediate portion is separated from the body of the shield by the subassembly housing.

8. The connector subassembly of claim 5, wherein:
for each of the plurality of conductive elements, the intermediate portion further comprises a third subportion disposed closer to the tail end than the first subportion; and
the body of the shield extends beyond an edge of the subassembly housing and overlaps the third subportions of the intermediate portions of the plurality of conductive elements.

9. The connector subassembly of claim 5, wherein:
the plurality of conductive elements comprise conductive elements configured for signal disposed between the selected ones configured for ground;
the shield is a first shield; and
the connector subassembly further comprises
a second shield comprising a plateau disposed above at least a portion of the second subportion of the intermediate portion of a respective signal conductive element; and
a valley attached to at least a portion of the second subportion of the intermediate portion of a respective ground conductive element.

10. The connector subassembly of claim 9, wherein:
the second subportion of the intermediate portion of the signal conductive element is spaced from the plateau by a third distance;
a center of the second subportion of the intermediate portion of the respective signal conductive element is spaced from an edge of the second subportion of the intermediate portion of the respective ground conductive element by a fourth distance; and
the third distance is less than or equal to the fourth distance.

11. An electrical connector comprising:
a housing comprising a side wall, the side wall comprising a first portion having a plurality of channels and a second portion having a space recessed into the side wall and aligned with the plurality of channels in a row;
a plurality of conductive elements held in the subassembly housing, each of the plurality of conductive elements comprising a mating end, a tail end opposite to the mating end, and an intermediate portion extending between the mating end and the tail end, the plurality of conductive elements comprising a first plurality of conductive elements each disposed in a channel of the plurality of channels, and a second plurality of conductive elements disposed in the space; and
a subassembly housing holding the second plurality of conductive elements in the space.

12. The electrical connector of claim 11, wherein:
the side wall comprises a third portion disposed between the first portion and the second portion and offset from the row, the third portion comprising a second plurality of channels; and
the plurality of conductive elements comprise a third plurality of conductive elements each disposed in a channel of the second plurality of channels.

13. The electrical connector of claim 11, comprising:
a shield disposed between the subassembly housing and the second portion of the side wall, wherein:
the second plurality of conductive elements comprise signal conductive elements disposed between ground conductive elements;
the subassembly housing comprises a plurality of openings to intermediate portions of the ground conductive elements of the second plurality of conductive elements; and
the shield comprises a plurality of rib each extending into a respective one of the plurality of openings of the subassembly housing.

14. The electrical connector of claim 13, wherein:
the shield is a first shield;
the electrical connector comprises a second shield disposed closer to the mating ends of the second plurality of conductive elements than the first shield; and
the second shield comprises a plurality of plateaus disposed above respective ones of the signal conductive elements and a plurality of valleys attached to respective ones of the ground conductive elements.

15. The electrical connector of claim 14, wherein:
the second portion of the side wall of the housing comprises an opening positioned in a moving path of the second shield.

16. The electrical connector of claim 11, wherein:
the side wall of the housing is a first side wall;
the row is a first row;
the housing comprises a second side wall opposite the first side wall and having a space recessed into the second side wall;
the plurality of conductive elements comprise a fourth plurality of conductive elements disposed in the space of the second side wall of the housing;
the subassembly housing is a first subassembly housing; and
the electrical connector comprises a second subassembly housing holding the fourth plurality of conductive elements in the space of the second side wall of the housing in a second row parallel to the first row.

17. The electrical connector of claim 16, further comprising:
a first shield disposed between the first subassembly housing and the second portion of the first side wall and electrically connected to selected ones of the second plurality of conductive elements;
a second shield disposed on the second plurality of conductive elements and electrically connected to the selected ones of the second plurality of conductive elements at locations closer to the mating ends of the second plurality of conductive elements than the first shield;
a third shield disposed between the second subassembly housing and the second side wall and electrically connected to selected ones of the fourth plurality of conductive elements; and
at least one fourth shield disposed on the fourth plurality of conductive elements and electrically connected to the selected ones of the fourth plurality of conductive elements at locations closer to the mating ends of the fourth plurality of conductive elements than the third shield.

18. The electrical connector of 17, wherein:
the second portion of the first side wall of the housing comprises an opening positioned in a moving path of the second shield; and
the second side wall of the housing comprises one or more openings positioned in a moving path of the at least one fourth shield.

19. An electrical connector comprising:
a housing comprising a first side wall, a second side wall, and a slot disposed and elongated between the first and second side walls;
a subassembly comprising a subassembly housing held by the first side wall and a plurality of conductive elements held in the subassembly housing, each of the plurality of conductive elements comprising a mating end curving into the slot, a tail end opposite the mating end and extending out of the housing, and an intermediate portion extending between the mating end and the tail end; and
a shield disposed on the intermediate portions of the plurality of conductive elements of the subassembly and electrically connected to selected ones of the plurality of conductive elements and separated from the rest of the plurality of conductive elements.

20. The electrical connector of claim 19, wherein:
the shield is separated from the rest of the plurality of conductive elements by the subassembly housing or air.
